(19) United States
(12) Patent Application Publication
(10) Pub. No.: US 2026/0159653 A1
(43) Pub. Date: Jun. 11, 2026

(54) OXIDATIVE FUNCTIONALIZATION OF POLYMERS USING NON-THERMAL ATMOSPHERIC PLASMA

(71) Applicants: Dionisios G. Vlachos, Newark, DE (US); LaShanda Korley, Newark, DE (US); Zoé O. G. Schyns, Newark, DE (US); Darien Nguyen, Newark, DE (US)

(72) Inventors: Dionisios G. Vlachos, Newark, DE (US); LaShanda Korley, Newark, DE (US); Zoé O. G. Schyns, Newark, DE (US); Darien Nguyen, Newark, DE (US)

(73) Assignee: University of Delaware, Newark, DE (US)

(21) Appl. No.: 19/412,278

(22) Filed: Dec. 8, 2025

Related U.S. Application Data
(60) Provisional application No. 63/728,812, filed on Dec. 6, 2024.

(51) Int. Cl. C08J 3/28; C08L 67/04

(52) U.S. Cl. CPC C08J 3/28; C08L 67/04; C08J 2323/06; C08J 2391/06; C08L 2205/08

(57) ABSTRACT

Disclosed herein are methods for oxidizing polymers and waxes with a non-thermal atmospheric plasma process. Blends and articles containing the oxidized polymers and waxes are also disclosed.

### CROSS-REFERENCE TO RELATED APPLICATION

This application claims priority to U.S. Provisional Patent Application No. 63/728,812 filed on Dec. 6, 2024, the contents of which are incorporated herein by reference in their entirety for all purposes.

### STATEMENT REGARDING FEDERALLY SPONSORED RESEARCH

This invention was made with government support under Grant No. DE-SC0021166 awarded by the US Department of Energy. The government has certain rights in the invention.

### FIELD

The present disclosure relates to methods for oxidizing polymers and waxes with a non-thermal atmospheric plasma process.

### BACKGROUND

The steady increase in global plastics production over the past few decades, coupled with the linearity of current plastic lifecycles, has resulted in pervasive and ubiquitous plastics pollution. By the end of 2017, over seven billion tons of plastics waste were generated and of this accumulated plastics waste, only 10% was recycled primarily through mechanical means (i.e., plastics extrusion), during which the heat and shear forces degraded the polymers physical properties. Around 14% of the waste was incinerated for energy recovery (heat and electricity), offering a considerable reduction in waste volume while bypassing waste sorting and separation steps. However, such processes are not circular and can result in air pollution (particulate matter), greenhouse gas emissions, and toxic byproducts (heavy metals, dioxins, ash waste). The remaining 76% of the waste ended up in landfills, dumps, or the natural environment, thereby raising significant environmental and health concerns. Consequently, there is a growing problem with the environmental pollution caused by plastics waste.

One route toward addressing the growing environmental problem surrounding plastics waste is to upcycle the waste materials (i.e., modify the waste into new, valuable materials and chemicals).

Functionalized polyethylene (PE) and polyethylene wax (PEW), specifically oxidized PE and PEW, are increasingly sought after for their diverse applications in plastics processing, paints, coatings, and printing inks. The insertion of oxygen-containing functional groups along the polymer chain of these materials can significantly alter their properties by enhancing their adhesive strength and improving their compatibilization with immiscible polymers. These improvements could provide a means for addressing the issues associated with plastic contamination and sorting, which are significant barriers to producing high-quality, mechanically recycled plastics. By improving interfacial adhesion and phase dispersion of mixed polymers, compatibilization can also enhance the mechanical performance and durability of mechanically recycled plastics, thus supporting circularity in plastic waste management.

Functionalizing PE and PEW into value-added materials is challenging due to the stability of their homo-atom backbones. Oxidized PEs and PEWs are conventionally manufactured by organic syntheses, and these syntheses involve a two-step process that involves catalytic thermal decomposition of PEs followed by oxidation under high temperatures (>140° C.) and pressures (>1 atm) using various catalysts (e.g., KMnO₄). The oxidative functionalization of PEs, on the other hand, is less explored, as functionalized polymers, in general, are conventionally synthesized through copolymerization of ethylene with specialized monomers (e.g., acrylic acid, vinyl alcohol, ethylene oxide). While highly successful, these copolymerization processes are often hampered by catalyst poisoning caused by the polarity of the new functional groups. Additional reagents and process steps are also usually required to install protecting groups on these functional groups during polymerization, thus requiring the implementation of deprotection reactions in the syntheses to remove the protecting groups afterwards.

Controlling functional group incorporation remains difficult in copolymerization due to the different relative rates of monomer polymerization. Though current post-polymerization functionalization processes for waste plastics can extend the end-of-life use of plastic waste materials and have been shown to be effective oxidative upcycling tactics, these processes require complex metal catalysts (metal complexes and metalloenzymes), strong oxidants (acids, etc.), solvents (dichloroethane, etc.), high temperatures (>120° C.), and long treatment times, all of which increase negative environmental impacts and raise sustainability concerns.

Other common routes to achieve PE functionalization include solution- or extruder-based peroxide-initiated functionalization; yet these approaches necessitate the use of peroxides (dicumyl peroxide, benzolyl peroxide, etc.), which present additional safety challenges due to their sensitivity to heat and decomposition into explosive compounds. The use of peroxides for C—H activation also can negatively impact the properties of the polymer by inducing β-scission and reducing the polymer's overall molecular weight. Additionally, this type of functionalization typically requires one or more, depending upon final chemical requirements, functionalization agents, which can increase process costs. Finding a sustainable approach for directly and controllably functionalizing waxes and polymers with limited addition of chemicals can be game-changing for producing valuable products from plastic waste.

To address the foregoing issues with current PE functionalization processes and plastics waste accumulation in the environment, the present disclosure presents methods and systems that employ a non-thermal atmospheric plasma (NTAP) process to upcycle polyethylene plastic wastes into high value products.

NTAP is an electrified, green chemical manufacturing technology capable of molecular activation at ambient conditions by colliding energetic electrons with gas molecules to generate ions, free radicals, and excited species. Oxidative plasma has been extensively applied to rapidly functionalize polymer and carbon surfaces given the plasma's inability to penetrate non-porous materials. The inability to penetrate non-porous materials has limited reactions to the plasma/polymer interface. For solid polymers and substrates, the thickness of the reported affected layer ranges from a few nanometers to microns depending on the various plasma parameters, reactor designs, and substrate materials. Consequently, bulk functionalization of polymers using NTAP was not demonstrated nor suggested in the art.

This disclosure presents the first use of NTAP to control the bulk oxidative functionalization of solid PEWs and other polyethylene polymers.

### SUMMARY

Disclosed herein is a method for oxidizing a polymer or wax including (i.e., comprising) one or more of: placing and melting the polymer or wax on a ground electrode or on a dielectric between electrodes; supplying a power and a gas mixture to a high-voltage electrode positioned above the ground electrode; and/or subjecting the polymer or wax on the ground electrode to a non-thermal atmospheric plasma process until an oxidized polymer or wax forms.

Disclosed herein are blends including one or more of the oxidized polymers or waxes disclosed herein.

Disclosed herein are articles containing at least one of the oxidized polymers or waxes produced from the methods disclosed herein.

### BRIEF DESCRIPTION OF THE DRAWINGS

Other features and advantages of the compositions, devices and methods disclosed herein will be apparent to those skilled in the art reading the following detailed description in conjugation with the exemplary embodiments illustrated in the drawings, wherein:

FIG. 1 depicts a representative of current and voltage waveforms that can be used in a pulsed direct current (DC) plasma reactor to carry out the processes disclosed herein. Calculated power is about 1.9 W at the following plasma operating conditions: voltage: 9 kV, frequency: 5 kHz, duty cycle: 1%, O₂ feed molar percent: 1%, stir rate: 0 rpm, and temperature: 110° C.

FIG. 2 depicts an optical emission spectroscopy (OES) spectra of a He/O₂ plasma discharge at the following plasma operating conditions: voltage: 9 kV, frequency: 5 kHz, duty cycle: 1%, O₂ feed molar percent: 1%, stir rate: 0 rpm, and temperature: 110° C.

FIG. 3 depicts a Fourier Transform Infrared (FTIR) spectra of low-density PE (LDPE) (40 kg/mol) and LDPE-g-maleic anhydride (MAH) (40 kg/mol). MAH-relevant peaks are highlighted for grafted samples. Grafting reaction conditions: dicumyl peroxide initiator (0.1 wt %), MAH (1.5 wt %), 200° C., 100 rpm, and 3 minute mixing time.

FIG. 4 depicts sample molds with visible failure from tensile testing (10%/min) of (a) 5 wt % control blend, and (b) 5 wt % oxidized LDPE blend. The polymer blend is 70% LDPE (76 kg/mol) and 30% poly(lactic acid) (PLA) with the addition of 5 wt % neat LDPE (40 kg/mol) serving as the control or plasma-oxidized LDPE (40 kg/mol) corresponding to the plasma-oxidized sample. Plasma operating conditions: treatment time: 2 h, O2 feed molar percent: 2%, stir rate: 0 rpm, temperature: 150° C., and LDPE to C28 ratio of 1:1.

FIG. 5 depicts a schematic of a plasma-melt interface in a pin-to-plate reactor with an intensified charge-coupled device (iCCD) image of pulsed discharge.

FIG. 6 depicts X-ray photoelectron spectroscopy (XPS) atomic percentages of neat and plasma-treated PEW at various treatment times. Plasma operating conditions: O₂ feed molar percent: 1%, stir rate: 0 rpm, and temperature: 110° C. XPS conditions: survey scan at 20 eV and 100 ms dwell time.

FIG. 7 depicts an FTIR spectra of neat and plasma-treated PE wax (PEW) at various treatment times. Plasma operating conditions: O₂ feed molar percent: 1%, stir rate: 0 rpm, and temperature: 110° C. FTIR conditions: mercury cadmium telluride (MCTB) detector at 4.0 cm⁻¹ resolution and 32 scans.

FIG. 8 depicts a ¹H nuclear magnetic resonance (NMR) spectra of neat and plasma-treated PEW at various treatment times. Plasma operating conditions: O₂ feed molar percent: 1%, stir rate: 0 rpm, and temperature: 110° C. ¹H NMR conditions: 115° C. in 1,1,2,2-tetrachloroethane-d₂.

FIG. 9 depicts (a) CO₂ yield and (b) mass loss in solid and calculated mass lost to CO₂ for plasma treatment of a PEW at various treatment times. Plasma operating conditions: voltage: 9 kV, frequency: 5 kHz, duty cycle: 1%, O₂ feed molar percent: 1%, stir rate: 0 rpm, and temperature: 110° C.

FIG. 10 depicts a proposed reaction network for the oxidation of polyethylene using oxygen-rich plasma chemistry. X denotes oxygen groups, which could be peroxide, hydroxyl, and carbonyl groups. R represents crosslinking with another polymer radical chain.

FIG. 11 depicts oxygen percentages and types of functional group incorporation for a neat and plasma-oxidized PEW at varying treatment times. Carbonyl groups refer to middle chain C═O bonds while aldehyde groups refer to end chain C═O groups. Plasma operating conditions: O₂ feed molar percent: 2%, stir rate: 0 rpm, and temperature: 110° C.

FIG. 12 depicts oxygen percentages and types of functional group incorporation for a neat and plasma-oxidized PEW at varying O₂ feed molar percents. Carbonyl groups refer to middle chain C═O bonds while aldehyde groups refer to end chain C═O groups. Plasma operating conditions (unless otherwise specified): treatment time: 0.5 h, stir rate: 0 rpm, and temperature: 110° C.

FIG. 13 depicts oxygen percentages and types of functional group incorporation for a neat and plasma-oxidized PEW at varying stirring rates. Carbonyl groups refer to middle chain C═O bonds while aldehyde groups refer to end chain C═O groups. Plasma operating conditions: treatment time: 0.5 h, O₂ feed molar percent: 2%, and temperature: 110° C.

FIG. 14 depicts oxygen percentages and types of functional group incorporation for a neat and plasma-oxidized PEW at varying temperatures. Carbonyl groups refer to middle chain C═O bonds while aldehyde groups refer to end chain C═O groups. Plasma operating conditions: treatment time: 0.5 h, O₂ feed molar percent: 2%, and stir rate: 0 rpm.

FIG. 15 depicts the viscosity of neat PEWs at various temperatures as a function of shear rate at multiple testing temperatures (140-200° C.).

FIG. 16 depicts a differential scanning calorimetry (DSC) spectra of a neat and plasma-oxidized PEW at varying treatment times. Plasma operating conditions: O₂ feed molar percent: 1%, stir rate: 0 rpm, and temperature: 110° C. DSC conditions: ramps of 10° C. min⁻¹ from −50° C. to 200° C. DSC curves are from 2^{nd} heating curve, plotted exotherm up and arbitrarily shifted to compare peaks.

FIG. 17 depicts a thermogravimetric analysis (TGA) spectra of a neat and plasma-oxidized PEW at varying treatment times. Plasma operating conditions: O₂ feed molar percent: 1%, stir rate: 0 rpm, and temperature: 110° C. TGA conditions: ramp 10° C. min⁻¹ from 100-600° C. under N₂ gas.

FIG. 18 depicts high temperature gel permeation chromatography (HT-GPC) traces of a neat and plasma-oxidized PEW at varying treatment times. Plasma operating conditions: O₂ feed molar percent: 1%, stir rate: 0 rpm, and temperature: 110° C. HT-GPC: conducted in 1,2,4-trichlorobenzene and calibrated against polystyrene standards.

FIG. 19 depicts an exemplary DSC curve of a neat PEW with calculated melt enthalpy and peak temperature.

FIG. 20 depicts the first derivative of a TGA weight loss curve of a control and plasma-treated PEW. Dotted lines represent the maximum in the first derivative. Plasma operating conditions: treatment time: 4 h, voltage: 9 kV, frequency: 5 kHz, duty cycle: 1%, O₂ feed molar percent: 1%, stir rate: 0 rpm, and temperature: 110° C.

FIG. 21 depicts the acid number of neat, plasma-treated, and commercially oxidized waxes. Carbonyl groups refer to middle chain C═O bonds while aldehyde groups refer to end chain C═O groups. Plasma operating conditions: O₂ feed molar percent: 1%, stir rate: 0 rpm, and temperature: 110° C.

FIG. 22 depicts the oxygen percentages and functional group incorporation of neat, plasma-treated, and commercially oxidized waxes. Carbonyl groups refer to middle chain C═O bonds while aldehyde groups refer to end chain C═O groups. Plasma operating conditions: O₂ feed molar percent: 1%, stir rate: 0 rpm, and temperature: 110° C.

FIG. 23 depicts the oxygen percentages and functional groups incorporation of a neat and plasma-oxidized LDPE (40 kg/mol) at varying conditions. Plasma operating conditions (unless otherwise specified): O₂ feed molar percent: 2%, stir rate: 0 rpm, and LDPE to C₂₈ ratio of 1:0 (no viscosity modifier added).

FIG. 24 depicts the viscosity of a neat LDPE (40 kg/mol) and different ratios of LDPE/C₂₈ mixtures at various temperatures as a function of shear rate.

FIG. 25 depicts the zero-shear viscosity of LDPE/C₂₈ mixtures at various ratios and temperatures. Table reports actual zero-shear values.

FIG. 26 depicts the gravimetric analysis of a plasma-oxidized LDPE and a non-plasma-oxidized LDPE (40 kg/mol) at various treatment times. Plasma operating conditions (unless otherwise specified): O₂ feed molar percent: 2%, stir rate: 0 rpm, and LDPE to C₂₈ ratio of 1:0 (no viscosity modifier added).

FIG. 27 depicts a ¹H-NMR spectra of a neat and a plasma-treated LDPE (40 kg/mol) at various treatment times. Plasma operating conditions: treatment time: 2 h, O₂ feed molar percent: 2%, stir rate: 0 rpm, temperature: 150° C., and LDPE to C₂₈ ratio of 1:1.

FIG. 28 depicts oxygen percentages and functional group incorporations in a plasma-treated LDPE (40 kg mol⁻¹) at various (a) LDPE to C₂₈ ratios at two temperatures and (b) treatment times at 150° C. and LDPE to C₂₈ ratio of 1:1. Carbonyl groups refer to middle chain C═O bonds while aldehyde groups refer to end chain C═O groups. Plasma operating conditions: treatment time: 2 h, O₂ feed molar percent: 2%, stir rate: 0 rpm.

FIG. 29 depicts recovered unreacted n-C₂₈ and product yield of the extracted plasma-oxidized n-C₂₈. Plasma operating conditions: treatment time: 2 h, O₂ feed molar percent: 2%, stir rate: 0 rpm, temperature: 150° C., and LDPE to C₂₈ ratio of 1:1.

FIG. 30 depicts oxygen percentages and functional group incorporations in a plasma-treated LDPE (76 kg/mol) at various LDPE to C₂₈ ratios at two temperatures. Carbonyl groups refer to middle chain C═O bonds while aldehyde groups refer to end chain C═O groups. Plasma operating conditions: treatment time: 2 h, O₂ feed molar percent: 2%, stir rate: 0 rpm.

FIG. 31 depicts (a) DSC, (b) TGA, and (c) GPC of a neat and a plasma-oxidized LDPE (40 kg/mol) at varying treatment times. Plasma operating conditions: treatment time: 2 h, O₂ feed molar percent: 2%, stir rate: 0 rpm, temperature: 150° C., and LDPE to C₂₈ ratio of 1:1. DSC conditions: ramps of 10° C./min from −50° C. to 200° C. DSC curves are from the 2nd heating curve, plotted exotherm up and arbitrarily shifted to compare peaks. TGA conditions: ramp 10° C./min from 100 to 600° C. under N₂ gas. HT-GPC conducted in 1,2,4-trichlorobenzene and calibrated against polystyrene standards.

FIG. 32 depicts scanning electron microscopy (SEM) images of a fractured control polymer blend (a-c) and 5 wt % plasma-oxidized LDPE polymer blend (d-f). The polymer blend is 70% LDPE (76 kg mol⁻¹) and 30% PLA with the addition of 5 wt % neat LDPE (40 kg mol⁻¹) acting as the control or plasma-oxidized LDPE (3.5%, oxygen incorporation, 40 kg mol⁻¹) acting as a compatibilizer. Plasma operating conditions for plasma-oxidized LDPE: treatment time: 2 h, O₂ feed molar percent: 2%, stir rate: 0 rpm, temperature: 150° C., and LDPE to C₂₈ ratio of 1:1.

FIG. 33 depicts (a) a stress-strain curve, (b) the Young's modulus, (c) the elongation-at-break, and (d) the toughness from tensile tests (10% per min) of a control and plasma-oxidized blends at 5 wt %. The polymer blend is 70% LDPE (76 kg mol⁻¹) and 30% PLA with the addition of 5 wt % neat LDPE (40 kg mol⁻¹) acting as the control or plasma-oxidized LDPE (3.5% oxygen incorporation, 40 kg mol⁻¹) acting as compatibilizer. Plasma operating conditions for plasma-oxidized LDPE: treatment time: 2 h, O₂ feed molar percent: 2%, stir rate: 0 rpm, temperature: 150° C., and LDPE to C₂₈ ratio of 1:1. Errors represent the standard error across 6 replicates per sample type (n=6).

### DETAILED DESCRIPTION

All publications, patent applications, patents, and other references mentioned herein are incorporated by reference in their entirety. Unless otherwise defined, all technical and scientific terms used herein have the same meaning as commonly understood by one of ordinary skill in the art to which this invention belongs. In case of conflict, the present specification, including definitions, will control.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

As used herein, the term “about” refers to a value that is ±5% of the stated value. In addition, it is understood that reference to a range of a first value to a second value includes the range of the stated values, e.g., a range of about 1 to about 5 also includes the more precise range of 1 to 5. It is also understood that the ranges disclosed herein include any selected subrange within the stated range, e.g., a subrange of about 50 to about 60 is contemplated in a disclosed range of about 1 to about 100.

One aspect of the present disclosure is a method for oxidizing a polymer or wax including one or more of: placing and melting the polymer or wax on a ground electrode or on a dielectric between electrodes; supplying a power and a gas mixture to a high-voltage electrode positioned above the ground electrode; and/or subjecting the polymer or wax on the ground electrode to a non-thermal atmospheric plasma (NTAP) process until an oxidized polyethylene polymer or wax forms.

In exemplary embodiments, the NTAP process is conducted in a plasma reactor. Any plasma reactor capable of producing and maintaining a plasma field can be used to conduct the NTAP process (see e.g., Bruggeman, P. J. et al., “Plasma-liquid interactions: a review and roadmap”, Plasma Sources Sci. Technol., 2016, 25. 053002).

In exemplary embodiments, the polymer or wax on the ground electrode is subjected to the NTAP process for about 0 hours to about 24 h, about 30 min to 12 h, about 30 min to about 4 h, about 1 h to about 12 h, about 1 h to about 6 h, or about 2 h to about 6 h. The amount of time the polymer or wax on the ground electrode is subjected to the NTAP process depends upon the composition of the polymer or wax (e.g., on the melting temperature, the softening temperature, the chemical structure and the amount of polymer or wax) and can in some embodiments extend beyond 24 h. With the benefit of the present disclosure in combination with their general understanding of the art, those of ordinary skill in the art can accurately determine how much time the polymer or wax needs to be subjected to the NTAP process to achieve a desired degree of oxidation. Those of ordinary skill in the art will also appreciate that the polymer or wax can be subjected to the NTAP process until signs of polymer or wax degradation begin to appear (e.g., when the polymer or wax melt begins to brown). Once signs of degradation begin to appear, the NTAP process should be halted and the polymer or wax melt should be collected.

In exemplary embodiments, the power supplied to the high-voltage electrode ranges from about 0.1 W to about 5 W, about 0.5 W to about 4 W, about 1.0 W to about 3.0 W, or about 1.5 W to about 2.0 W. The power supplied to the high-voltage electrode can vary depending on the degree of polymer or wax oxidation to be achieved (e.g., lower powers can be used to provide a lower degree of oxidation and higher powers can be used to provide a higher degree of oxidation) and the composition of the polymer or wax melt. In exemplary embodiments, the power supplied to the high-voltage electrode is above 5 W. With the benefit of the present disclosure in combination with their general understanding of the art, those of ordinary skill in the art can accurately determine how much power to supply to the high-voltage electrode to achieve a desired degree of oxidation in the polymer or wax.

In exemplary embodiments, the high-voltage electrode is a pin configuration (e.g., those seen in pin-to-plate plasma reactor), a plate configuration (e.g., those seen in a plate-to-plate plasma reactor), a multi-needle array configuration (e.g., those seen in multi-needle array plasma reactors), a hollow-tube configuration (e.g., those seen in hollow electrode plasma reactors), or in a gliding discharge configuration. The high-voltage electrode can be in any configuration known in the art to initiate and sustain a plasma field in a plasma reactor.

The power supplied to the high-voltage electrode can be provided by a DC power supply, an AC power supply or any power generating device capable of supplying power to the high-voltage electrode.

In exemplary embodiments, the ground electrode is in a planar configuration, a cylindrical configuration, a spherical configuration, a linear configuration, a step configuration, a diverging configuration (such as those seen in plasma reactors that use arc torches), a coil-shaped configuration, or any configuration that is commonly employed in plasma reactors.

In exemplary embodiments, the dielectric is an insulating material selected from, but not limited to, a ceramic (e.g., glass or porcelain), silicon, or a plastic.

In exemplary embodiments, the gas mixture supplied to the high-voltage electrode includes one or more of atmospheric oxygen, helium, water vapor, hydrogen peroxide, one or more inert gases (e.g., argon, nitrogen, neon, krypton, xenon, radon) or combinations thereof.

In exemplary embodiments, the high-voltage electrode is position 0 cm or about 1.5 cm above the ground electrode. The position of the high-voltage electrode above the ground electrode or the dielectric can impact the power required to generate the plasma field. Moving the high-voltage electrode closer to the ground electrode or dielectric reduces the power needed to create the plasma field, while moving the high-voltage electrode farther from the ground electrode or dielectric increases the power needed to create the plasma field. With the benefit of the present disclosure in combination with their general understanding of the art, those of ordinary skill in the art can accurately determine what position to place the high-voltage electrode above the ground electrode or the dielectric to achieve a desired degree of oxidation in the polymer or wax.

The high-voltage electrode and the ground electrode can possess or be produced from any conductive material commonly used in the art (e.g., metals like copper, silver, and platinum, carbon-based materials such as graphite and graphene, and various conductive polymers like polyaniline and polypyrrole).

In exemplary embodiments, the NTAP process occurs at a temperature ranging from about 100° C. to about 300° C., about 120° C. to about 180° C., or about 140° C. to about 160° C. The temperature at which the NTAP process is conducted depends upon the composition of the polymer or wax melt (e.g., on the melting temperature, the softening temperature, the chemical structure and the amount of polymer or wax) and the degree of oxidation to be achieved. In exemplary embodiments, NTAP process occurs at a temperature below 100° C. or above 200° C. With the benefit of the present disclosure in combination with their general understanding of the art, those of ordinary skill in the art can accurately determine what temperature to conduct the NTAP process to achieve a desired degree of oxidation in the polymer or wax.

In exemplary embodiments, the NTAP process is conducted under a stirring rate of 0 rpm to about 600 rpm, about 0 rpm to about 300 rpm, about 50 rpm to about 500 rpm, about 100 rpm to about 400 rpm, or about 200 rpm to about 300 rpm. The stirring rate at which the NTAP process is conducted at depends upon the composition of the polymer or wax melt (e.g., on the melting temperature, the softening temperature, the chemical structure and the amount of polymer or wax) and the degree of oxidation to be achieved. In exemplary embodiments, the NTAP process is stirred at a rate above 600 rpm. With the benefit of the present disclosure in combination with their general understanding of the art, those of ordinary skill in the art can accurately determine what stirring rate to conduct the NTAP process to achieve a desired degree of oxidation in the polymer or wax.

The stirring of the polymer or wax melt can be carried out under a magnetic field with a magnetic stir rod, with an impeller stirrer, or with any other device capable of stirring the polymer or wax melt.

In exemplary embodiments, the NTAP process occurs under a O₂ feed molar fraction of 0% to about 100%, about 10% to about 90%, about 20% to about 70%, about 30% to about 50%, or about 0.1% to about 4%. As used herein, the “O₂ molar feed fraction” is the percentage of oxygen in the gas mixture that is supplied to the high-voltage electrode or flowed into a plasma reactor. For example, a gas mixture supplying 40 SCCM O₂ and 960 SCCM He to the high-voltage electrode or a plasma reactor would have a O₂ feed molar fraction of 4%. Those of ordinary skill in the art will appreciate that higher amounts of power will need to be supplied to the high-voltage electrode to ignite gas mixtures containing higher O₂ feed molar fractions. The O₂ molar feed fraction to use in the gas mixture depends upon the composition of the polymer or wax melt (e.g., on the melting temperature, the softening temperature, the chemical structure and the amount of polymer or wax) and the degree of oxidation to be achieved. With the benefit of the present disclosure in combination with their general understanding of the art, those of ordinary skill in the art can accurately determine what O₂ molar feed fraction to use in the gas mixture to achieve a desired degree of oxidation in the polymer or wax.

In exemplary embodiments, the NTAP process incorporates about 4 mol % to about 10 mol % oxygen into a backbone of the polymer or into the wax (i.e., the NTAP process can incorporate an amount of oxygen into a backbone of the polymer or into the wax to where the amount of oxygen functional groups contributes about 4 mol % to about 10 mol % (oxygen group per monomer) of the polymer or wax). Oxygen incorporation is based on a per monomer basis of each polymer or wax. So, for example, a 4 mol % oxygen incorporation means that out of 100 moles of atoms per monomer, 4 moles are oxygen atoms. The oxygen can be incorporated into the polymer or wax as a hydroxyl group (—OH), a carbonyl group (C═O), and/or an aldehyde group (—CH═O). To determine the bulk amount of oxygen that the NTAP process has incorporated into the polymer or the wax, one skilled in the art can subject the polymer or wax to high temperature NMR spectroscopy and calculate the integrals of each peak corresponding to oxygenated species. The integrals for each peak corresponding to oxygenated species can then be compared to the integrals of the peaks corresponding to the bonds in the polymer backbone or of the wax. The oxygen incorporation amount or percentage can then be determined by dividing the total area of all the integrals by the integrals of the oxygenated species. XPS can also be used to determine the total surface oxygen percentage by measuring the chemical shift in the binding energy of core-level electrons. By analyzing the spectrum of emitted photoelectrons, one skilled in the art can identify elements and their chemical states, such as distinguishing between carbon atoms in different bonding environments (e.g., C—C, C—O, C═O). The peak positions shift based on the oxidation state, allowing for quantitative analysis of the degree of oxidation of the polymer or wax. FTIR can be used to determine which oxygen-containing functional groups (e.g., alcohols, carbonyls and aldehydes) have been incorporated into the polymer or wax.

In exemplary embodiments, the oxidized wax contains an acid number ranging from about 3 to about 20. The acid number of the oxidized wax is dependent upon the amount of time the wax is subjected to the NTAP process and the power supplied to the high-voltage electron. In exemplary embodiments, the oxidized wax contains an acid number above 20. The amount of time to subject the wax to the NTAP process and the amount of power to supply to the high-voltage electrode depends upon the composition of the wax melt (e.g., on the melting temperature, the softening temperature, the chemical structure and the amount of wax) and the degree of oxidation to be achieved. With the benefit of the present disclosure in combination with their general understanding of the art, those of ordinary skill in the art can accurately determine the amount of power to use and the amount of time to subject the wax to the NTAP process to achieve a desired acid number in the oxidized wax.

In exemplary embodiments, the oxidized polymer or wax contains, based on a total molar percentage of oxygen groups present in the oxidized polymer or wax, about 0.5 mol % to about 70 mol % alcohol groups, about 0.5 mol % to about 70 mol % carbonyl groups and about 0.5 mol % to about 10 mol % aldehyde groups.

In exemplary embodiments, the polymer or the wax is selected from, but not limited to, a polyethylene wax or polymer (e.g., a high-density polyethylene (HDPE), a low-density polyethylene (LDPE), a linear low-density polyethylene (LLDPE), or a ultra-high-molecular-weight polyethylene (UHMWPE)), a polypropylene wax or polymer, a polystyrene wax or polymer, a polybutene-1 polymer, a polymethylpentene wax or polymer, or any polymer or waxes that (i) can produce a melt at the temperatures ranges disclosed herein and (ii) possess backbones or structures amenable to oxidation (e.g., those that contain double bonds, tertiary carbon atoms, or secondary carbon atoms).

In exemplary embodiments, the polymer placed on the ground electrode is part of a solution that also contains at least one solvent. The at least one solvent can be, but is not limited to, n-octacosane or any other alkane that possesses a melting temperature below 100° C. or a melting point that is compatible with the polymer (i.e., one that will also allow the alkane to melt with the polymer and not cause the solvent to evaporate out of the melt), a degradation temperature above 200° C., and/or the ability to form a single-phase solution with the polymer. At least one solvent can be added to the polymer melt to reduce the viscosity of the melt.

The melt should possess a viscosity that allows for the melt to be thoroughly stirred and exposed to the plasma field generated by the gas mixture and the electrodes. Examples of acceptable melt viscosities include, but are not limited to, those falling within the range of about 1×10¹ Pa·s to 1×10⁻² Pa·s.

In exemplary embodiments, the solution contains a ratio of polymer-to-solvent of about 1:3 to about 3:1. The optimal polymer-to-solvent ratio to use for the solution depends, at least in part, on the molecular weight of the polymer. For example, polymers of lower molecular weights achieve higher degrees of oxidation when present in a solution that has about a 1:1 polymer-to-solvent ratio; whereas polymers of higher molecular weights achieve higher degrees of oxidation when present in solutions that have higher amounts of solvent (e.g., those possessing a 1:3 polymer-to-solvent ratio).

Another aspect of the present disclosure is a polymer blend including one or more of the oxidized polymers or waxes discloses herein, at least one oxygen-atom-containing polymer, and at least one or more additional polymers.

In exemplary embodiments, the polymer blend includes about 0.1 wt % to about 10 wt % of the oxidized polymer or wax, about 20 wt % to about 30 wt % of the at least one oxygen-atom-containing polymer, and about 60 wt % to about 70 wt % of the one or more additional polymers. The additional polymers included in the blend can be selected from, but are not limited to, functionalized polyolefin polymers (e.g., ethylene-vinyl acetate (EVA) copolymers, ethylene-methyl acrylate (EMA) copolymers, and ethylene-acrylic acid (EAA) copolymers), polyethylene polymers (e.g., a high-density polyethylene (HDPE), a low-density polyethylene (LDPE), a linear low-density polyethylene (LLDPE), or a ultra-high-molecular-weight polyethylene (UHMWPE)), polypropylene polymers, polystyrene polymers, polybutene-1 polymers, or polymethylpentene polymers.

The at least one oxygen-atom-containing polymer can be selected from, but is not limited to, poly(lactic acid), poly(ethylene terephthalate), poly(methyl methacrylate), ethylene vinyl alcohol, and ethyl vinyl acetate.

In exemplary embodiments, the polymer blend possesses a strain-at-break that is at least 70% higher than a strain-at-break of a comparable polymer blend, wherein the comparable polymer blend (i) contains the one or more additional polymers and the at least one oxygen-containing polymer of the polymer blend in the same weight percentages as the polymer blend, and (ii) contains at least one non-oxidized polymer or wax instead of the at least one oxidized polymer or wax of the polymer blend, wherein the at least one non-oxidized polymer or wax is present in the comparable polymer blend in a weight percentage that is the same as the weight percentage that the at least one oxidized polymer or wax contributes to the polymer blend.

In exemplary embodiments, the polymer blend possesses a Young's modulus that is at least 30% higher than a Young's modulus of a comparable polymer blend, wherein the comparable polymer blend (i) contains the one or more additional polymers and the at least one oxygen-containing polymer of the polymer blend in the same weight percentages as the polymer blend, and (ii) contains at least one non-oxidized polymer or wax instead of the at least one oxidized polymer or wax of the polymer blend, wherein the at least one non-oxidized polymer or wax is present in the comparable polymer blend in a weight percentage that is the same as the weight percentage that the at least one oxidized polymer or wax contributes to the polymer blend.

In exemplary embodiments, the polymer blend possesses a toughness that is at least 160% higher than a toughness of a comparable polymer blend, wherein the comparable polymer blend (i) contains the one or more additional polymers and the at least one oxygen-containing polymer of the polymer blend in the same weight percentages as the polymer blend, and (ii) contains at least one non-oxidized polymer or wax instead of the at least one oxidized polymer or wax of the polymer blend, wherein the at least one non-oxidized polymer or wax is present in the comparable polymer blend in a weight percentage that is the same as the weight percentage that the at least one oxidized polymer or wax contributes to the polymer blend.

Another aspect of the present disclosure is an article produced from or including an oxidized polymer or wax disclosed herein, wherein the article is selected from, but not limited to, a paint, a coating, a compatibilizer for plastic blends, a grafted polymer, an adhesive, an emulsifier, a floor polish, an ink, a textile, a lubricant, or a resin.

### EXAMPLES

The present disclosure will be described in more detail with reference to the following Examples, which shows exemplary embodiments in accordance with the present disclosure. The present disclosure is not limited to these exemplary embodiments.

### Example 1

### Materials and Methods of Example 1

### Chemicals

Oxygen (99.997%) and helium (99.999%) gases were purchased from KeenGas. Hexanes, n-octacosane (99%), n-hexadecane (99%), 1-hexandecanol (99%), 3-hexadecanone (98%), LDPE (weight-average molecular weight (M_{w}) about 76 kg mol⁻¹), methylene chloride (>99.8%), tetrahydrofuran (>99.9%), dicumyl peroxide (DCP), maleic anhydride (MAH), and ethylene glycol (>99%) were purchased from Sigma-Aldrich. 1,1,2,2-tetrachlor-oethane-d₂ (>99%), 1,2,4-trichlorobenzene, and butylated hydroxytoluene were obtained from Fisher Scientific. LDPE (M_{w} about 40 kg mol⁻¹) was obtained from SciPoly. 4043D poly (lactic acid) (PLA) was obtained from Filabot. E 06 K PE wax, EO 75 K oxidized PE wax (5-9 acid number), and EO 78 K oxidized PE wax (20-24 acid number) were obtained by Deurex.

### Plasma Reactor and Diagnostics

Details of the plasma reactor used in this Example can be found in Nguyen et al. (D. K. Nguyen et al., Oxidative Functionalization of Long-Chain Liquid Alkanes by Pulsed Plasma Discharges at Atmospheric Pressure, ACS Sustainable Chem. Eng., 2022, 10(48), 15749-15759). Briefly, plasma oxidation of PE occurred in a pin-to-plate reactor configuration. PE pellets (about 250 mg) were placed at the bottom of a glass reactor (17 mm diameter) heated using an external hotplate. A micro stir bar was added at the bottom of the glass reactor to induce convection in the polymer melt. To maintain a controlled gas atmosphere within the reactor, helium and oxygen gas mixtures were introduced (500 sccm) via mass flow controllers (Brooks GF 40 series). A high-voltage, stainless-steel pin was positioned above the melt surface, while a grounded, stainless-steel plate was placed at the exterior bottom of the glass vessel. The gap between the pin and plate was 7 mm, with the PE melt and glass vessel serving as dielectrics. Non-thermal, atmospheric-pressure plasma was generated using a direct current (DC) pulsed, high-voltage (HV) power supply (HVPPS1160—High Voltage Laboratory, University of Patras). The peak-to-peak voltage, frequency, and duty cycle were kept constant at 9 kV, 5 kHz, and 1%, respectively, leading to a calculated dissipated power of about 1.9 W.

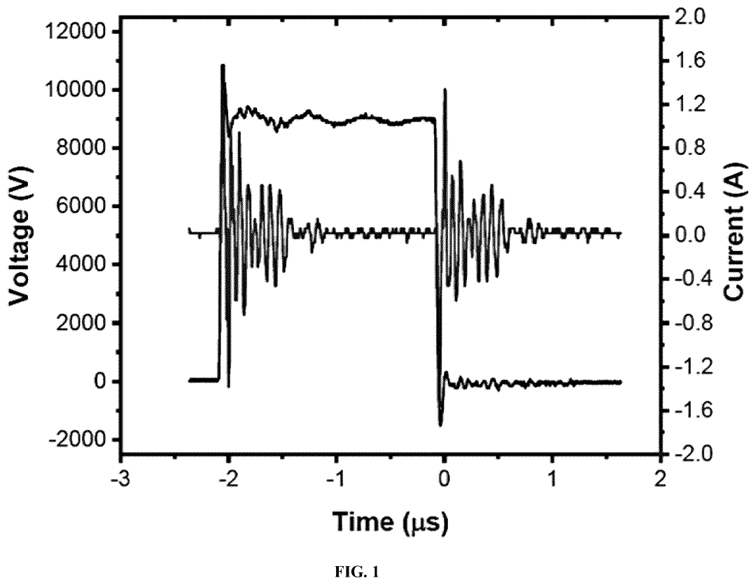

The voltage and current signals were recorded using a high-voltage probe (Tektronix P6015) and a current monitor (Pearson 6585). Both signals were acquired in real time using a Tektronix MDO32 wideband oscilloscope. A characteristic oscillogram is shown in FIG. 1. The average dissipated power (i.e., the power consumed by the plasma discharge) was calculated using the following equation:

$$P = \frac{1}{{T}_{p}} {\int }_{0}^{{T}_{p}} v ( t ) i ( t ) dt \qquad ( 1 )$$

in which Tₚ corresponds to the period of each wave, and v(t) and i(t) are the time-dependent voltage and current, respectively.

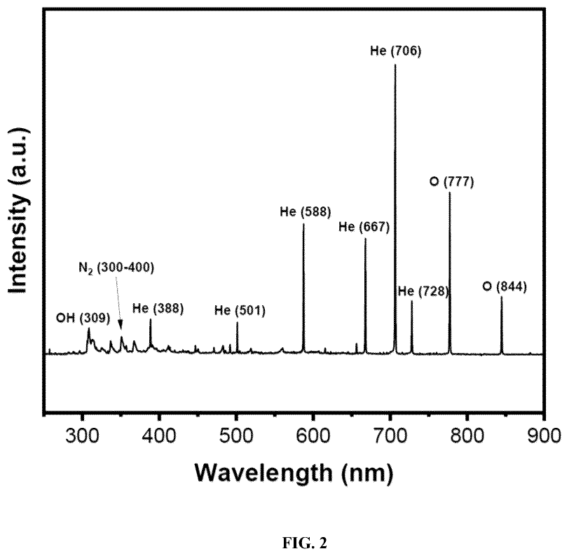

Optical emission spectroscopy (OES) measurements were performed using an AvaSpec-ULS4096CL-EVO spectrometer (Avantes). An optical fiber (400 μm) was used to collect the light emission from the plasma and the wideband emission spectrum in the region 300-900 nm was recorded and analyzed with the Avasoft software. A characteristic emission spectrum of the He/O₂ discharge is shown in FIG. 2.

### Viscosity Characterization

The viscosity of the starting waxes and polymers was determined using rheological tests on an ARES G2 rheometer (TA Instruments) equipped with either 25 mm stainless steel or 50 mm titanium parallel plates under N₂ flow. PE waxes were loaded onto preheated 50 mm plates (110, 140, and 170° C.) and trimmed before testing at a gap of 0.5 mm. Prior to testing, a 60 s, 1 s⁻¹ pre-shear was performed to remove any stresses arising during loading. Flow sweeps were performed from 50-1000 s⁻¹ with a maximum equilibration time of 3 minutes. LDPE polymer samples were loaded onto preheated 25 mm plates (150 or 180° C.) and trimmed before testing at a gap of 0.5 mm. Prior to testing, a 60 s, 1 s⁻¹ pre-shear was performed to remove any stresses arising during loading. Flow sweeps were performed from 0.1-100 s⁻¹ (150° C.) and 10-100 s⁻¹ (180° C.) with a maximum equilibration time of 3 min.

### Product Analysis

The resulting re-solidified product was analyzed using spectroscopic, thermal, and chromatographic characterizations to determine the resulting oxygen content and identify any changes to the properties of the polymer. To measure oxidation of the polymer, variable-temperature nuclear magnetic resonance (NMR) spectroscopy, Fourier-transform infrared (FTIR) spectroscopy, mirage-FTIR (mIRage), and X-ray photoelectron spectroscopy (XPS) were employed. For polymer property analysis, differential scanning calorimetry (DSC), thermogravimetric analysis (TGA), and high-temperature gel permeation chromatography (HT-GPC) were conducted.

### Polymer Oxidation

Surface analysis of the re-solidified product was conducted using FTIR, mIRage, and XPS. FTIR spectroscopy was performed on a Nicolet iS50 coupled with a golden gate diamond attenuated total reflectance module (ATR) and an MCTB detector at 4.0 cm⁻¹ resolution using an average of 32 scans. MIRage submicron IR spectroscopy (Photothermal Spectroscopy Corp) was conducted on the cross-section of the molten product analyzing the IR range from 800-1920 cm⁻¹. XPS was performed using a Thermo Fisher K-Alpha instrument equipped with an Al (K) X-ray. Spectra were obtained with pass energies of 20, 10, and 20 eV for the survey, C 1s, and O 1s spectra, respectively, at 100 ms dwell time.

Bulk oxidation of the polymer chain was quantified using quantitative proton (¹H) NMR analysis (AVIII 400 MHz spectrometer equipped with a Bruker BBO Probe and a BBI Probe). Prior to NMR, the polymer solid was dissolved in 1,1,2,2-tetrachloroethane-d₂ (TCE-d₂). NMR spectroscopy was conducted at 115° C.

Untreated control ¹H NMR: (400 MHz, TCE-d₂) δ 0.9-1 (CH₃—CH₂—) 1.3-1.5 (—CH₂—).

Oxidized polymer ¹H NMR: (400 MHz, TCE-d₂) δ 0.9-1 (CH₃—CH₂—), 1.3-1.5 (—CH₂—), 2.4 (CHO—CH₂—), 3.6 (OH—CH₂—), 3.8 (—CH₂—CH₂O—CH₂—), 5.5 (—CH₂—(CH)₂—CH₂—), 9.8 (s, CHO—CH₂—).

The oxygen mol % corresponding to aldehyde, ketone, and primary and secondary alcohol incorporation along the backbone was determined quantitatively from the NMR spectra. The relative integrals between backbone CH₂ protons and proton peaks arising from, or adjacent to, oxygen-containing functional groups were calculated and converted to 02 mol %. Full spectra, assignments, and example calculations are presented in Fig. S3.

### Polymer Crosslinking

The degree of polymer crosslinking was estimated by determining the gel fraction of samples via Soxhlet extraction in xylenes in a similar fashion to ASTM 2765-16. Polymer samples (about 0.4 g) were loaded into washed cellulose thimbles and placed within the Soxhlet apparatus. The flask was filled with 200 mL of xylenes and heated (about 160° C.) to achieve about 10 min extraction cycles. After the first extraction cycle, the process was continued for 24 hours. The resulting insoluble fraction was vacuum dried at 70° C. for 24 hours and weighed.

### Thermal Analysis

DSC was conducted on a Discovery DSC (TA Instruments). Samples (about 5 mg) were sealed in an aluminum T_{zero} pan with lids. Samples were equilibrated to 30° C., ramped to 200° C. at 10° C. min⁻¹, cooled at 10° C. min⁻¹ to −50° C., before being ramped to 200° C., under N₂ atmosphere. Analyses were performed on second heating traces on TRIOS software (TA Instruments) unless specified otherwise. Crystallinities were calculated according to eqn (2). ΔHₘ and ΔH_{c} are the melting and cold crystallization (if present) enthalpies of the sample, respectively, and ΔH° is the melting enthalpy (293 J g⁻¹) of the perfect PE crystal.

$$\% crystallinity = \frac{Δ {H}_{m} - Δ {H}_{c}}{Δ {H}_{m} °} \times 100$$

TGA was performed on a Discovery TGA (TA Instruments). Samples were ramped from 40° C. to 600° C. at 10° C. min⁻¹ under N₂ atmosphere. Analyses were performed using the TRIOS software (TA Instruments) unless specified otherwise.

### HT-GPC

Molecular weight characterization of oxidized and non-oxidized PE products was conducted using a HLC-8312GPC/HT HT-GPC (TOSOH Bioscience) in 1,2,4-trichlorobenzene. Samples were dissolved in the mobile phase (1,2,4-trichloro-benzene with 500 ppm BHT) at about 2 mg mL⁻¹ concentration and dissolved under stirring for 2 h at 140° C. 300 μL injections of sample solutions were eluted at 0.8 mL min⁻¹ at 140° C. through two TSKgel GMHHR-H(20)HT columns in series, with refractive index (RI) and differential viscometer detectors. Molecular weight calculations were calibrated using 12 narrow polystyrene standards (6×10²-2×10⁶ g mol⁻¹) and corrected according to the Mark-Houwink relationships for PE (see Z. R. Hinton et al., Antioxidant-induced transformations of a metal-acid hydrocracking catalyst in the deconstruction of polyethylene waste, Green Chem., 2022, 24(19), 7332-7339).

### Solvent Extraction and Quantification

N-octacosane was added to LDPE to reduce the viscosity. After oxidation, 7 mL of hexanes was added to the solid melt and sonicated for 15 min to extract the n-octacosane (C₂₈) and corresponding oxygenates from the solidified LDPE melt. The solids were filtered and dried in an oven at 75° C. overnight. This process was repeated twice to ensure complete extraction of the lower molecular weight compounds from the LDPE. For quantification of extracted n-octacosane and corresponding oxygenates, the dissolved products were analyzed using a gas chromatography-flame ionization detector (GC-FID) (Agilent 7890B) with an Agilent J&W HP-INNOWax column (30 m, 0.25 mm, 0.25 μm) and GC-MS (Shimadzu GCMS-QP2010) with an Agilent J&W HP-INNOWax column (30 m, 0.25 mm, 0.25 μm). Calibration curves were constructed using external standards of n-hexadecane, 1-hexadecanol, and 3-hexadecanone and adjusted to the response factor of n-octacosane. The conversion of n-alkane was calculated as follows.

$$n - Alkane conversion ( \% ) = \frac{{nC}_{i} - {nC}_{f}}{{nC}_{i}} \times 100 \%$$

where nCᵢ corresponds to the initial moles of carbon in the reactant, and nC_{f} corresponds to the unreacted moles of carbon. The product yield was determined by the following equation:

$$Product yield ( \% ) = \frac{{nC}_{product}}{{nC}_{i}} \times 100 \%$$

where nC_{product} refers to the moles of carbon in the oxygenated products and nCᵢ is the initial moles of carbon in the n-alkane.

For gas-phase analysis, gas-sampling bags were used to collect the reactor's output at sequential times throughout the plasma experiments and analyzed using a Micro GC (Agilent 990), which allows the quantification of CH₄, C₂H₆, C₂H₄, CO₂, O₂, etc. Gaseous components, such as CO₂ and O₂, were quantified using external standard calibrations. To assess the possible formation of lighter gaseous species and evaporation, the outlet gas was bubbled through an acetone solvent trap in an ice bath and analyzed in the GC.

### Generation of Polymer Blends, Characterization, and Testing

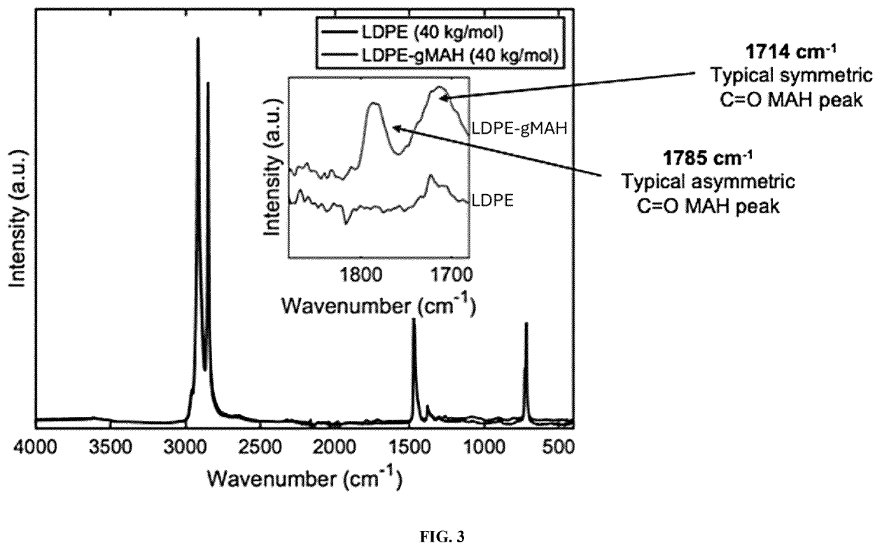

Polymer blends were produced using a MiniLab III microcompounder (Thermo Scientific) at 200° C. under an N₂ atmosphere with a screw speed of 100 rpm. Samples were compounded for 3 min under “cycle” mode before extruding into filaments and left to cool in air. 70 wt % LDPE (NM about 76 kg mol⁻¹) and 30 wt % PLA were compounded with 5 wt % of neat LDPE (NM about 40 kg mol⁻¹), plasma-oxidized LDPE (M_{w} about 40 kg mol⁻¹) to produce controls and samples. Additional samples for interfacial testing were produced by blending 5 wt % plasma-oxidized LDPE (M_{w} about 40 kg mol⁻¹) with LDPE (M_{w} about 76 kg mol⁻¹). Supplemental LDPE-gMAH samples were generated by blending 40 kg mol⁻¹ LDPE with 0.1 wt % DCP (initiator) and 1.5 wt % MAH using the conditions described above (confirmed via FTIR, FIG. 3). The LDPE-gMAH was then compounded with 70 wt % LDPE (M_{w} about 76 kg mol⁻¹) and 30 wt % PLA at identical conditions.

Thermal properties of the LDPE/PLA polymer blends with and without compatibilizer were analyzed using DSC and TGA as previously described. Crystallinities were calculated according to the following equation

$$\% crystallinity = \frac{Δ {H}_{m} - Δ {H}_{c}}{{w}_{i} \times Δ {H}_{m} °} \times 100$$

ΔHₘ and ΔH_{c} are the melting and cold crystallization (if present) enthalpies of the sample, respectively, ΔH°ₘ is the melting enthalpy (293 J g⁻¹) of either a perfect PE crystal or (93 J g⁻¹) PLA crystal, and wᵢ is the weight fraction of the polymer in the blend.

To visualize LDPE/PLA phase behavior, scanning electron microscopy (SEM) was conducted on the polymer blends using a JEOL JSM 7400F-SEM. Samples were immersed in liquid N₂, fractured, and sputter-coated with a thin layer of gold-palladium alloy for 60 s before imaging.

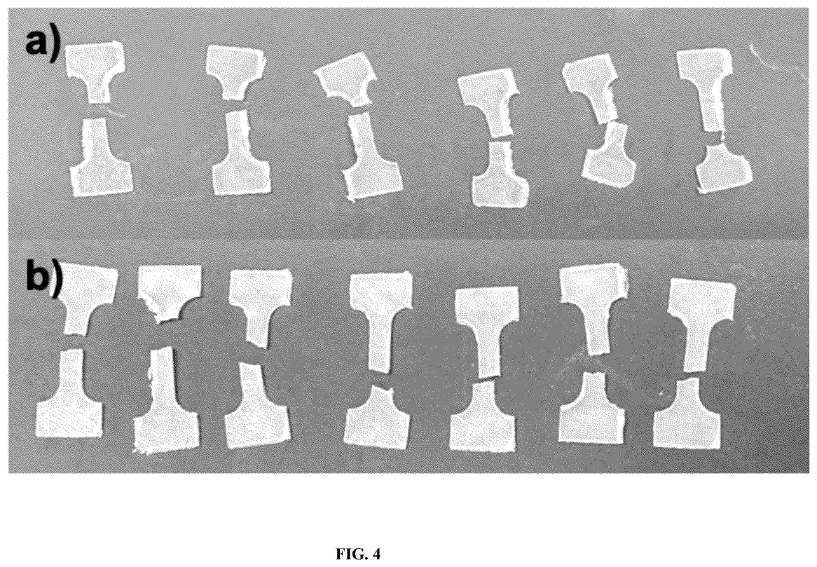

Tensile testing was conducted on LDPE/PLA polymer blends with and without compatibilizer using a Zwick/Roell Z 0.5 (500 N zwicki-Line) tensile tester with a 200 N load cell, a clamp force of 200 N, and tested at a constant strain rate of 10% per min. Prior to tensile testing, all LDPE/PLA polymer blends with and without compatibilizer were pressed into films using a hot press with pre-heated plates at 200° C. for 30 s at above 500 psi. Samples were then cut from molded films using a specialized cutter to produce dumbbell samples with dimensions of about 9.5 mm×about 2.5 mm×about 0.1 mm (FIG. 4). The Young's modulus was calculated from the linear region of the stress-strain curves.

Contact angle analysis was performed using a VCA Optima (AST Products Inc.) video contact angle system. Prior to testing, PLA, LDPE, and LDPE+5 wt % O-LDPE were pressed into films using a hot press with pre-heated plates at 200° C. for 30 s at about 500 psi. The contact angle between the polymer sample and water and ethylene glycol was analyzed via the ImageJ contact angle plug-in tool. The surface tension between PLA/LDPE and PLA/LDPE+O-LDPE was estimated according to Wu's method (see S. Wu, Calculation of interfacial tension in polymer systems, J. Polym. Sci., Part C: Polym. Symp., 1971, 34(1), 19-30; I. Charfeddine, J. C. et al., Surface tension and interfacial tension of polyolefins and polyolefin blends, J. Appl. Polym. Sci., 2022, 139(14), 51885; and G. Guerrica-Echevarria, J. I. Eguiazábal and J. Nazábal, Interfacial tension as a parameter to characterize the miscibility level of polymer blends, Polym. Test., 2000, 19(7), 849-854). Briefly, by measuring the contact angle between a material and two liquids with known dispersive (γ^{d}) and polar (γ^{p}) components of surface tension (γ=γ^{d}+γ^{p}), γ^{d} and γ^{p} of the material can be estimated using the following equation.

$$( 1 + cos θ ) {γ}_{L} = \frac{4 {γ}_{S}^{d} {γ}_{L}^{d}}{{γ}_{S}^{d} + {γ}_{L}^{d}} + \frac{4 {γ}_{S}^{p} {γ}_{L}^{p}}{( {γ}_{S}^{p} + {γ}_{L}^{p} )}$$

where γ_{L} is the surface tension of the liquid, θ is the measured contact angle between the liquid and the solid, γ^{d}_{S} and γ^{d}_{L} are the dispersive components of the interfacial tension of the solid and the liquid, respectively, and γ^{p}_{S} and γ^{p}_{L} are the polar components of the interfacial tension of the solid and liquid respectively. Since γ^{d}_{L} and γ^{p}_{L} are known values (water 21.8 and 51.0 mJ m⁻², respectively; ethylene glycol: 29.0 and 21.8 mJ m⁻², respectively), the interfacial tension between the two polymers (1 and 2) can be calculated by the following equation:

$${γ}_{1 , 2} = {γ}_{1} + {γ}_{2} + \frac{4 {γ}_{1}^{d} {γ}_{2}^{d}}{{γ}_{1}^{d} + {γ}_{2}^{2}} + \frac{4 {γ}_{1}^{p} {γ}_{2}^{p}}{( {γ}_{1}^{p} + {γ}_{2}^{p} )}$$

where γ^{d} and γ^{p} are the dispersive and polar components of the surface tension of the two polymers (subscripts 1 and 2), and γ_{1,2} is the interfacial tension between two polymers (1 and 2).

### Experiments and Results of Example 1

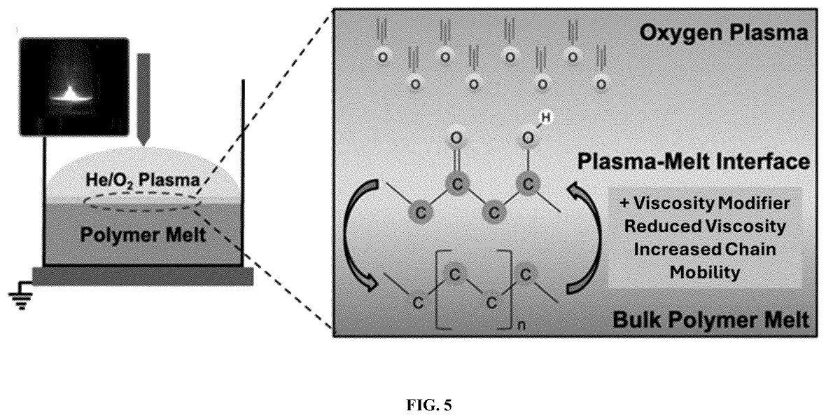

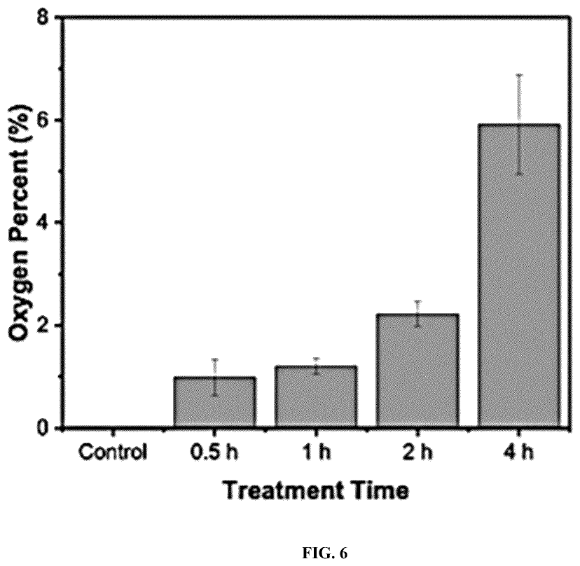

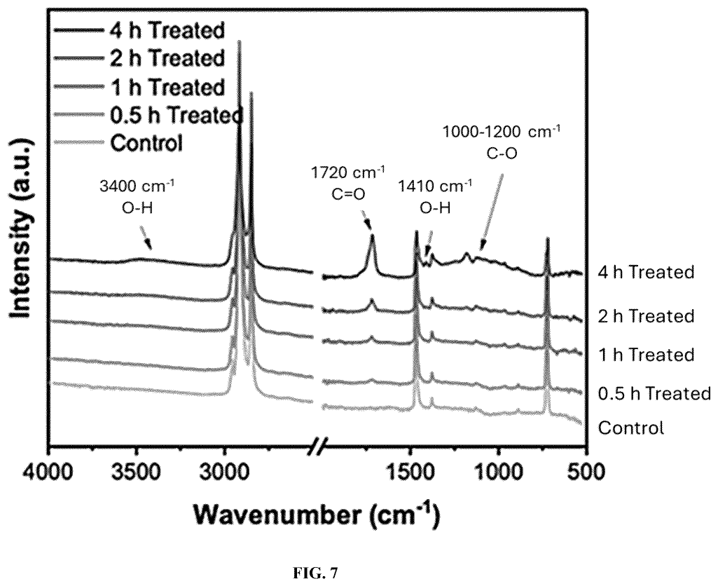

Plasma oxidation was initially performed on the PEW by melting the wax (>110° C.) and impinging the oxygen plasma on the surface of the melt (FIG. 5). Operating at these higher temperatures reduced the viscosity of PEW and increased chain mobility and diffusion of oxygenated groups, thus enabling bulk oxyfunctionalization. Oxygen incorporation in the polymer wax was studied using X-ray photoelectron spectroscopy (XPS), Fourier-transform infrared (FTIR) spectroscopy, and variable-temperature 1H nuclear magnetic resonance (NMR) spectroscopy (FIGS. 6-8). XPS determined the atomic percentage of oxygen species on the resolidified PEW surface (FIG. 6). Longer plasma treatment times increased the oxygen incorporation, reaching up to about 6% after 4 h. The FTIR spectra confirmed the presence of carbonyl and hydroxyl groups (FIG. 7). A sharp peak at 1720 cm⁻¹ and a broad peak around 1000-1200 cm⁻¹ were attributed to CvO stretching and C—O stretching vibrations, respectively. Additionally, a broad peak at 3400 cm⁻¹ and a sharp peak at 1410 cm⁻¹ were assigned to O—H stretching. The relative intensity of these peaks increased, compared to CH₂ symmetric and asymmetric stretches at about 2850 and about 2920 cm⁻¹, with longer plasma treatments, indicating higher oxygen content. The characteristic peaks of C—H bonds in methyl and methylene groups were dominant in all FTIR spectra (FIG. 7).

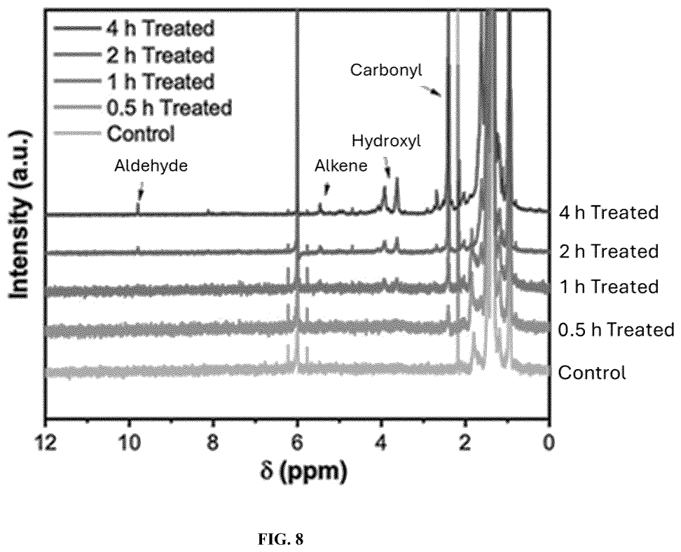

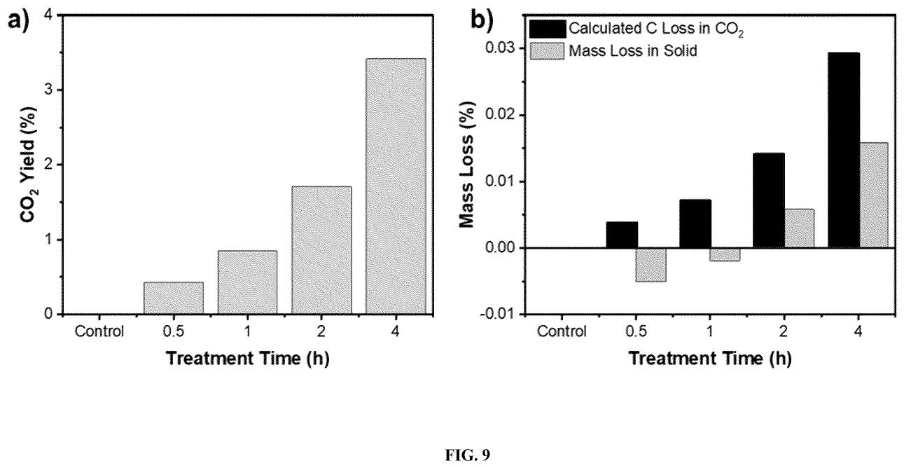

While FTIR and XPS could be utilized to examine both bulk and homogeneous oxidation by analyzing different faces of molten PEW (mid-plane and opposite), removal from the reactor vial and processing of the molten PEW proved difficult. Therefore, to provide evidence of homogeneous oxidation through the melt, submicron IR spectroscopy (mIRage) measurements on the cross-section of the molten PEW were performed. Spectra showed clear CvO stretching (1720 cm⁻¹) and C—H bending (1470 cm⁻¹) consistently across the cross-section, confirming uniform oxidation throughout the melt. To validate the bulk functionalization of the PEW in a more accurate, quantitative approach, ¹H NMR was conducted on dissolved samples (1,1,2,2 tetrachloroethane-d₂) (FIG. 8). Peaks corresponding to carbonyl (δ 2.4 ppm), hydroxyl (δ 3.6 ppm and 3.9 ppm), aldehyde (δ 9.8 ppm), and alkene (δ 5.5 ppm) groups emerged in NMR spectra at increasing treatment times. The dual hydroxyl peaks were due to primary (δ 3.9 ppm) and secondary alcohols (δ 3.6 ppm). By integrating the peaks relative to the methyl and methylene groups (δ 1.8-0.6 ppm), the functional group incorporation into the polymer chain (mol %) was calculated. Gravimetric, gas trap, and output stream analysis indicated negligible formation of exiting gas-phase hydrocarbons (FIG. 9). These results demonstrate that NTAP can achieve bulk oxidation of low molecular weight polymers, such as PEWs, through the plasma-melt interface, a process that has not been shown previously.

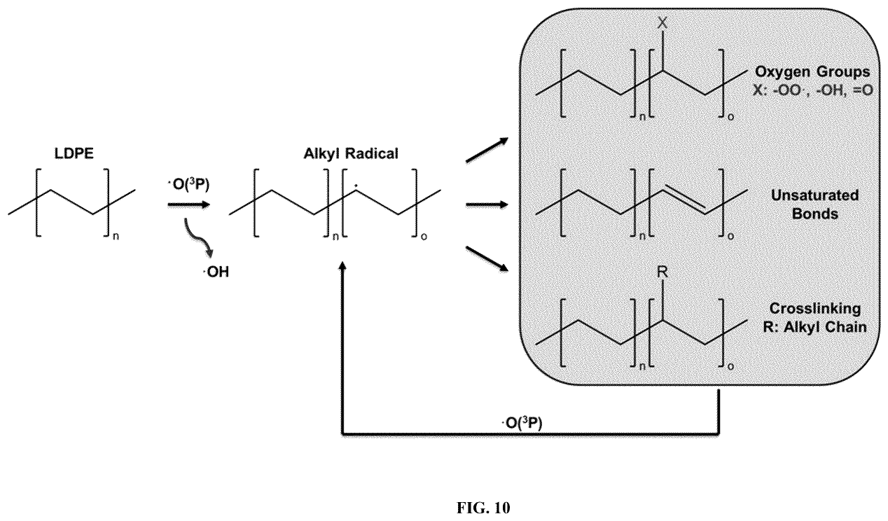

FIG. 10 depicts a reaction scheme for the oxidation of PEW or molten PE using oxygen-rich plasma chemistry based on the product distribution and previous literature, where the molten PE behaves similarly to liquid alkanes. The reaction is initiated by the hydrogen abstraction of the polymer chain by reactive oxygen species (O³P). Through recombination with abundant oxygen species, alkyl radicals form hydroxyl and peroxide groups. The hydroperoxide species are relatively unstable and readily dissociate into hydroxyl and carbonyl-containing species (i.e., aldehydes and ketones). Hydroxyl groups can also undergo oxidation to the corresponding aldehydes or ketones. Additionally, carbons connected with hydroxyl or aldehyde groups can undergo carbon-carbon cleavage, leading to chain scission. Consecutive hydrogen abstractions on a polymer chain can create multiple alkyl radicals, yielding alkene functional groups. Termination reactions between alkyl radicals can potentially lead to polymer crosslinking.

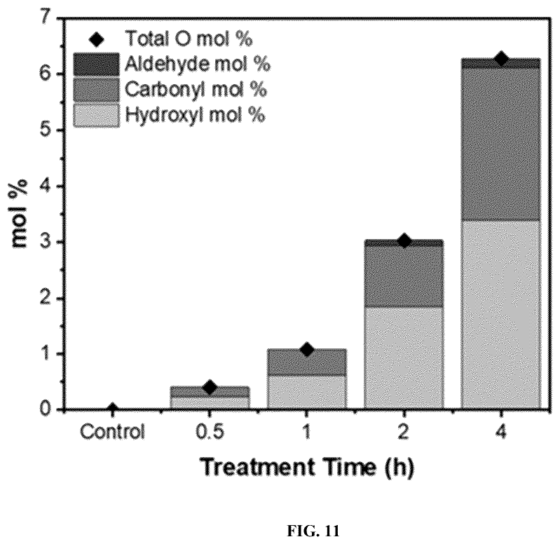

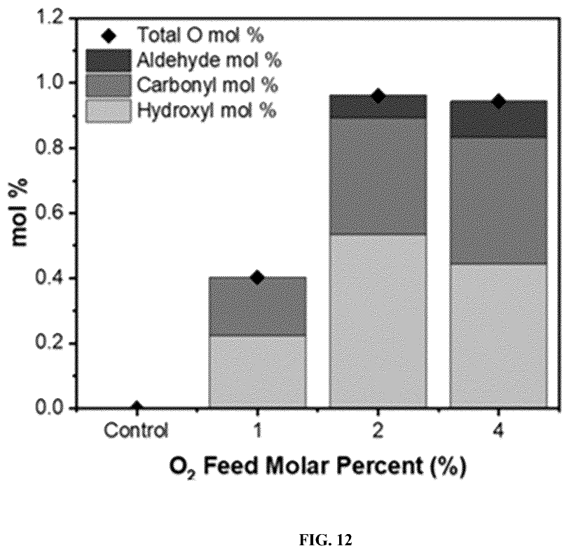

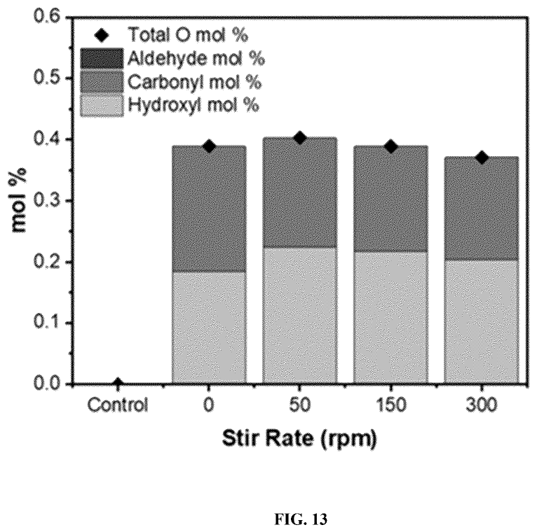

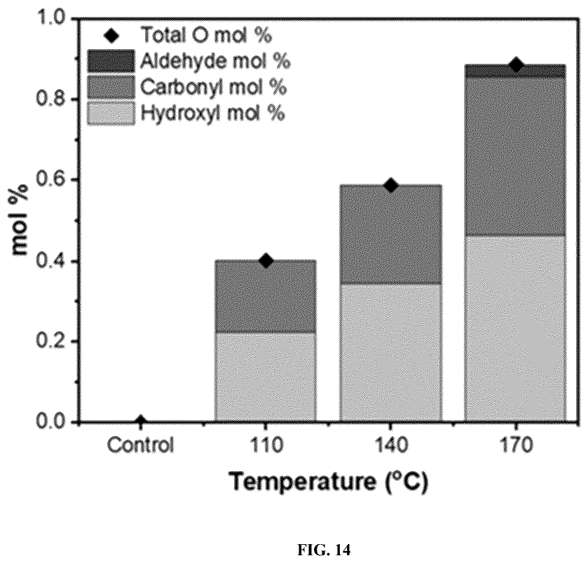

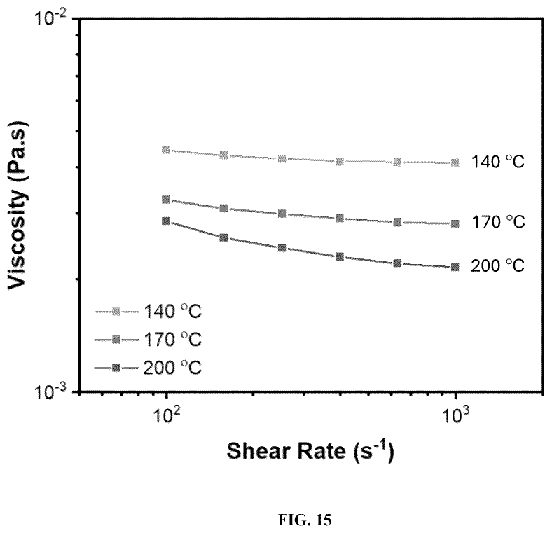

Presented in FIGS. 11-14 is the effect of treatment time, O₂ feed molar fraction, stir rate, and temperature on the oxidation of the PEW. All functional groups were quantified using ¹H NMR analysis (Materials and methods). Increasing treatment time led to greater oxygen functionality in the polymer chain due to longer residence times of the melt within the plasma reactor (FIG. 11). The calculated oxygen incorporation from ¹H NMR showed similar trends to the atomic oxygen percentage calculated by XPS (FIG. 5), indicating relatively uniform oxidation throughout the melt. Differences between XPS and NMR data can be associated with XPS being an extremely surface-sensitive technique and adsorbed O₂ from air (or plasma) on the surface of the PEW can cause variability. Higher O₂ feed molar percentages initially led to higher oxygen incorporation, but functionalization plateaued at 4% O₂ feed (FIG. 12). This plateau occurred because higher oxygen feed percentages lead to decreasing dissipated power at fixed applied voltages and frequencies. Additionally, the electronegative nature of O₂ reduces the electron density of the plasma, resulting in reduced generation of reactive oxygen species. Modifying the stirring rate from 0 to 300 rpm (FIG. 13) revealed minimal differences in oxidation, which can be attributed to the natural convection induced by the plasma impingement on the melt surface dominating PEW flow. Increasing the melt temperature from 110 to 170° C. (FIG. 14) increased oxidation from 0.4 to 0.9 mol % respectively, potentially due to (1) an increase in the vapor pressure of the melt, which allows for more gas-phase interactions, or (2) a decrease in the melt viscosity (FIG. 15), which can facilitate the diffusion of oxygen groups into the melt and the counter diffusion of functionalized and bulk polymer chains. Alcohol and carbonyl groups were in almost equal ratios at low oxygen incorporation. However, at higher oxidation intensities (i.e., higher O₂ inputs or longer treatment times), aldehyde groups became increasingly prevalent. This change in functionalization could result from further oxidation of alcohol groups or from carbon cleavage forming smaller-chain aldehydes. Overall, these results demonstrate that NTAP can controllably oxidize low molecular weight polymers (i.e., PEWs) purely in the melt phase by optimizing process conditions.

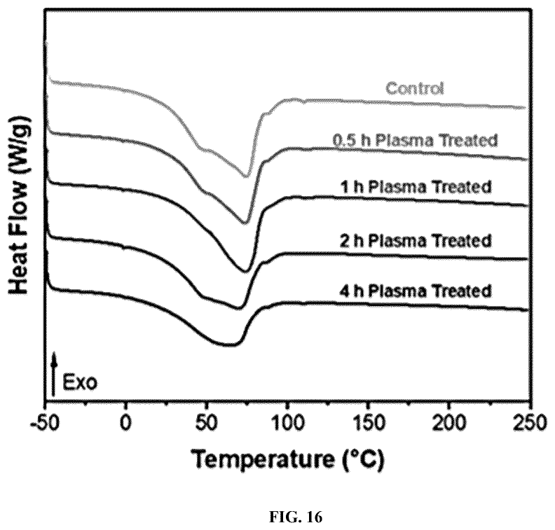

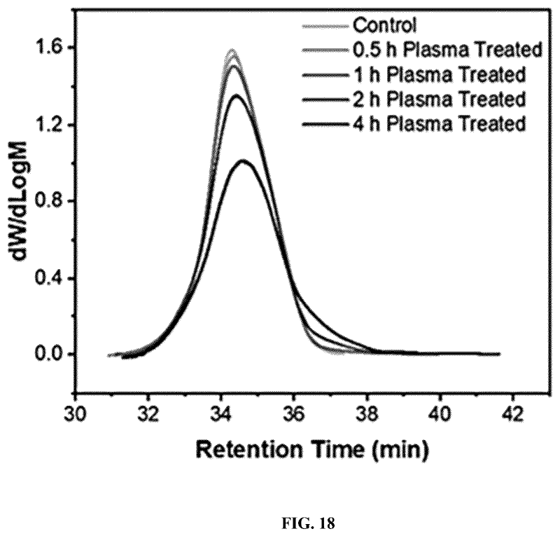

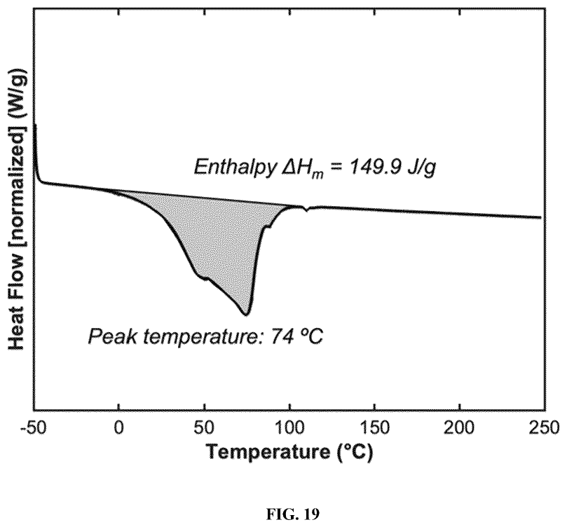

Differential scanning calorimetry (DSC), thermogravimetric analysis (TGA), and high-temperature gel permeation chromatography (HT-GPC) analysis (FIGS. 16-18) indicated several changes in PEW properties post-plasma treatment. DSC curves from second heating (FIG. 16) revealed that the control PEW has a melting point of about 75° C., which decreased with longer treatment times (i.e., higher oxidation). Additionally, the melting peak broadened and decreased in intensity. By calculating and comparing the melting enthalpy to that of a perfect PE crystal, the crystallinity of the final product was determined (FIG. 19 and Table 1). At higher treatment times, the crystallinity and melting point of the treated PEWs decreased, which could be due to the introduction of oxygen groups along the backbone disrupting the packing of polymer chains during crystallization.

TABLE 1
Melting Temperature, Enthalpy, and Calculated Crystallinity
for Neat and Plasma-oxidized PEW at Various Treatment Times

| | Melting Peak | | |
|---|---|---|---|
| | Maximum | | Crystal- |
| | Temperature | Enthalpy of | linity |
| Sample | (° C.) | Melting (J/g) | (%) |
| Control | 74.6 | 194.2 | 67.0 |

| | | | | |
|---|---|---|---|---|
| 0.5 | h | 74.1 | 174.0 | 60.0 |
| 1 | h | 74.2 | 154.0 | 53.1 |
| 2 | h | 69.8 | 153.6 | 53.0 |
| 4 | h | 60.5 | 121.6 | 41.9 |

| | | | |
|---|---|---|---|
| Deurex | 93.6 | 193.0 | 66.6 |
| EO 75K | | | |
| Deurex | 84.8 | 173.6 | 59.8 |
| EO 78K | | | |

DSC conditions: ramps of 10° C./min from −50° C. to 200° C. Plasma operating conditions: O₂ feed molar percent: 1%, stir rate: 0 rpm, and temperature: 110° C.

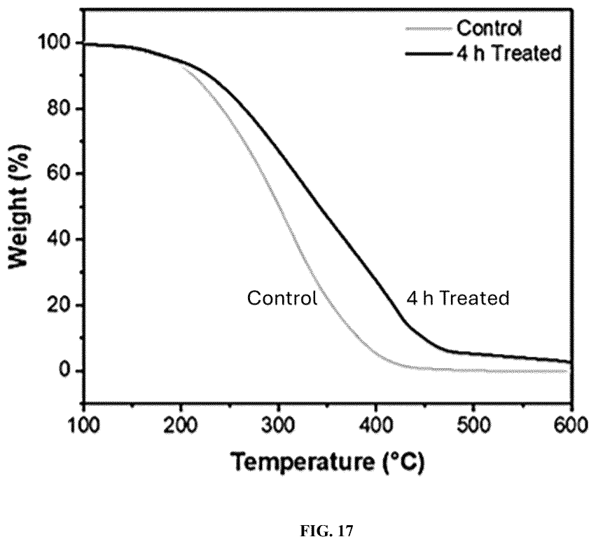

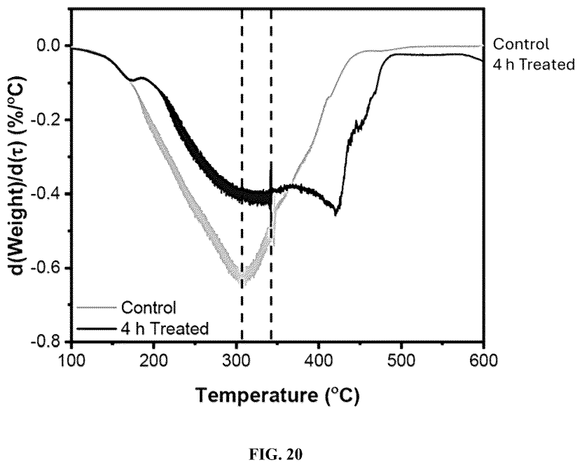

Additionally, crosslinking of the polymer chain and/or a decrease in the molecular weight of the polymer due to carbon cleavage can reduce crystallinity and melting temperature, both of which can occur at the plasma-melt interface. These competing effects were further revealed in TGA traces of the polymer before and after plasma treatment (FIG. 17), which indicated a higher decomposition temperature onset for the plasma-oxidized PEW compared to neat PEW. The peak of the first derivative of the TGA weight loss curve was approximately 310° C. for the control PEW and 340° C. for the plasma-treated PEW (FIG. 20), indicating that the most significant weight loss changes occurred at higher temperatures in the plasma-treated samples. This increased thermal stability could be tentatively attributed to the crosslinking of the polymer chain, which aligns with the DSC analysis, resulting in a polymer with slightly enhanced thermal stability. However, molecular weight distributions (MWD) from HT-GPC analysis showed broadening at longer plasma treatment times, accompanied by a shift toward higher retention times, indicating a slight decrease in the molecular weight due to oxidative carbon cleavage. As previously stated, both crosslinking and carbon cleavage reactions can occur simultaneously, but HT-GPC omits testing of cross-linked insoluble fractions of the sample. Therefore, the changes to the polymer architecture were complex, with a likely interplay between crosslinking and chain scission during plasma oxidation.

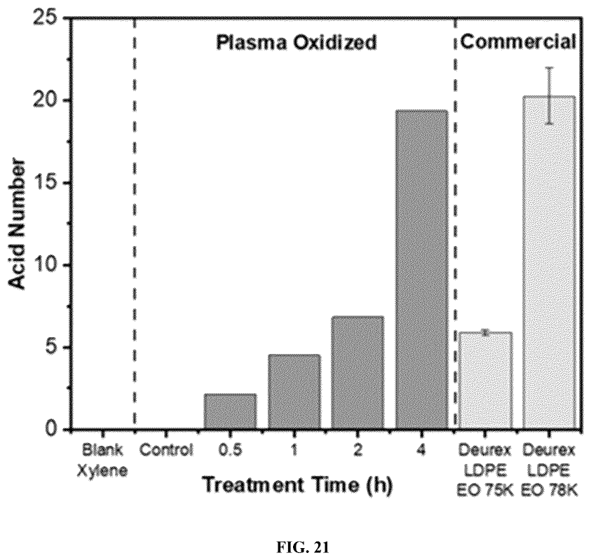

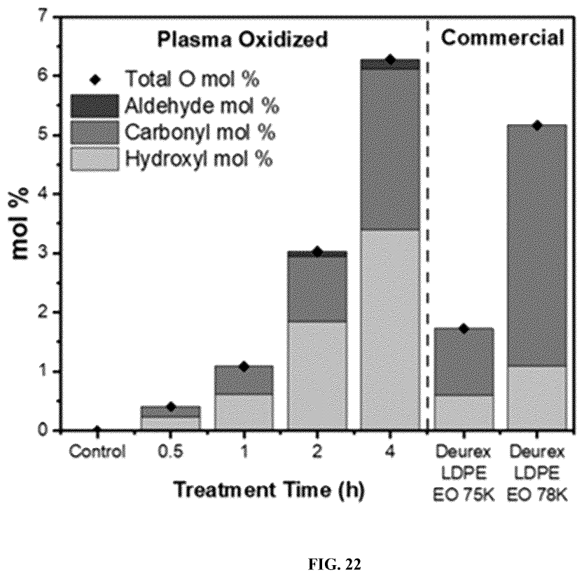

The acid number and oxygen mol % of plasma-oxidized PEW were compared to commercially available oxidized waxes of Deurex (FIGS. 21-22). The Deurex oxidized waxes (commercially named LDPE EO 75K and 78K) were obtained as representatives of commercially available, highly and lightly oxidized PEWs, with molecular weights expected to be similar to that of neat PEW. Higher acid numbers are characterized by greater oxidation of the polymer chain, as the acid number represents the milligrams of KOH needed to neutralize per gram of polymer. NTAP achieved acid numbers comparable to commercial oxidized waxes produced conventionally (i.e., at high pressures and temperatures), even under unoptimized conditions (FIG. 21). Plasma oxidation facilitated a larger diversity of functional groups than commercial waxes (FIG. 22), with hydroxyl and carbonyl groups in near-equal ratios and a small number of aldehyde groups at higher oxidation levels. In contrast, commercial oxidized waxes predominantly contained carbonyl groups with a small fraction of hydroxyl groups. Overall, plasma treatment can achieve similar acid numbers to commercial waxes in a controllable manner while introducing a diverse array of functional groups. Further comparisons of the thermal properties and molecular weights of plasma-oxidized and commercially oxidized waxes were conducted and showed that the commercially oxidized waxes exhibited substantially different molecular weights than the control PEW, suggesting their synthesis from a PEW of a higher starting molecular weight.

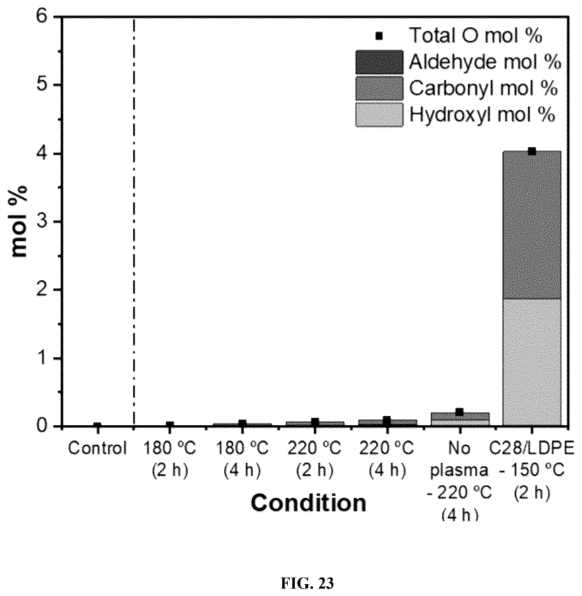

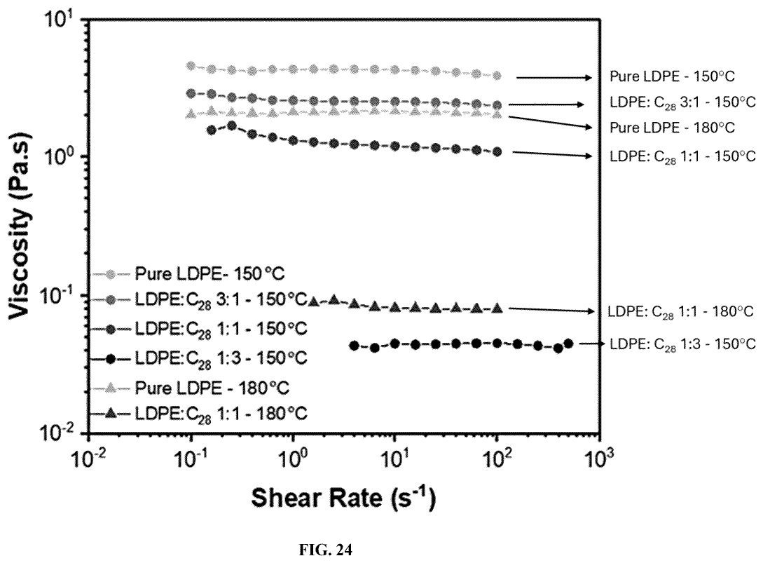

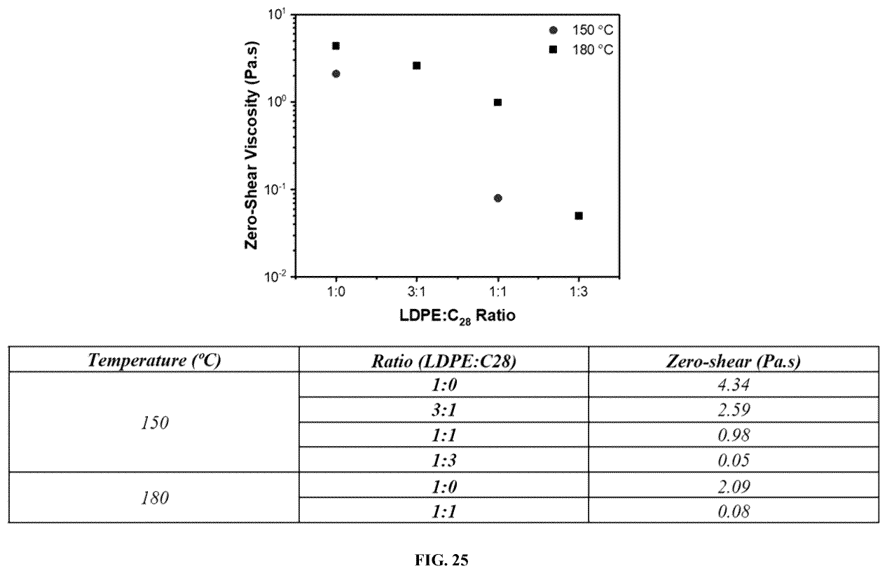

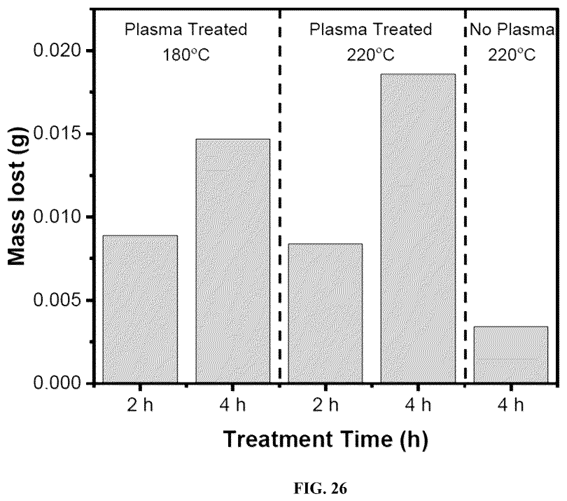

To assess the potential replacement of current commercial processes with plasma processes, a more detailed comparison using an identical starting PEW is essential to isolate plasma effects. Given the applicability of plasma functionalization over the spectrum of molecular weights, functionalization of any molecular weight PEW should be feasible. To test this theory, the functionalization of materials with molecular weights representative of LDPE products, LDPE (M_{w} about 40 kg mol⁻¹), was plasma treated. Bulk plasma oxidation of the neat LDPE proved challenging even at temperatures >200° C. and at the optimal conditions for PEW (FIG. 23). This challenge was attributed to the high viscosity of the molten LDPE (4.34 Pa·s—FIGS. 24-25), which could prevent the diffusion of the oxygen groups into the bulk and the counter diffusion of bulk melt. Instead of being bulk oxidized, the surface of the LDPE was overoxidized, leading to gas-phase oxygenates manifested as mass loss (FIG. 26). Additionally, autoxidation and polymer degradation prevailed at high temperatures in the open air (i.e., no plasma; FIG. 23).

In view of these findings, n-octacosane (n-C₂₈) was added to the melt at varying ratios (FIG. 5) to reduce the viscosity of the melt and the operating temperature. Since n-C₂₈ forms a homogeneous mixture with LDPE due to their chemical similarity, the addition of n-C₂₈ was hypothesized to only affect the melt viscosity and should not have any other chemical or physical effects on the system. n-C₂₈ was selected for its low vapor pressure to limit evaporation and gas-phase plasma reactions, similar oxidation to PEW, and simple extraction (i.e., via hexanes and sonication). Importantly, long-chain alkanes are produced by mild hydrogenolysis of plastic waste, making the whole process sustainable and enabling plastic circularity.

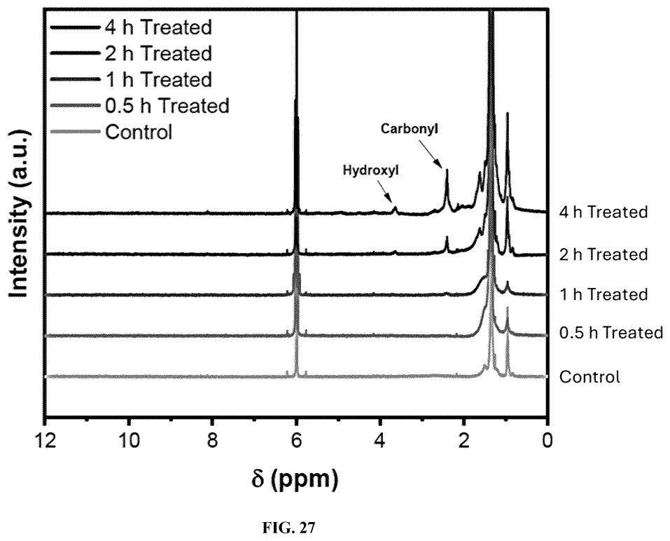

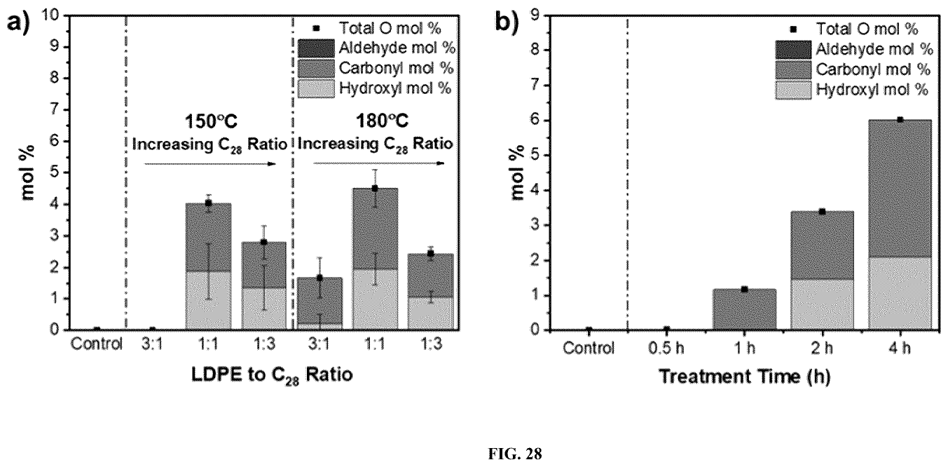

The oxygen of NTAP-treated LDPE, after removal of n-C₂₈, was estimated from the ¹H NMR spectra (FIG. 27). At 150° C. and 180° C., maximum oxidation of LDPE was observed for an LDPE:C₂₈ mixture with a ratio of 1:1, due to the mixture's viscosity and vapor pressure of C₂₈. Specifically, plasma oxidation of a 3:1 LDPE:C₂₈ blend was limited by the high viscosity, especially at lower temperatures. Conversely, for a 1:3 LDPE:C₂₈ blend, gas-phase C₂₈ can compete for electron dissociation and decrease plasma intensity, lowering functionalization. Higher melt temperatures impacted LDPE oxidation only slightly due to viscosity reduction. The temperature effect was most pronounced for 3:1 LDPE:C₂₈; no oxidation was observed at 150° C. vs. about 1% oxidation at 180° C. The temperature effect became negligible at high fractions of C₂₈ as the viscosity was sufficiently reduced. The tunability of functionalization was demonstrated by modulating the treatment time (FIG. 28). Up to 6 mol % oxidation of the polymer chain with simultaneous n-octacosane oxidation was achieved.

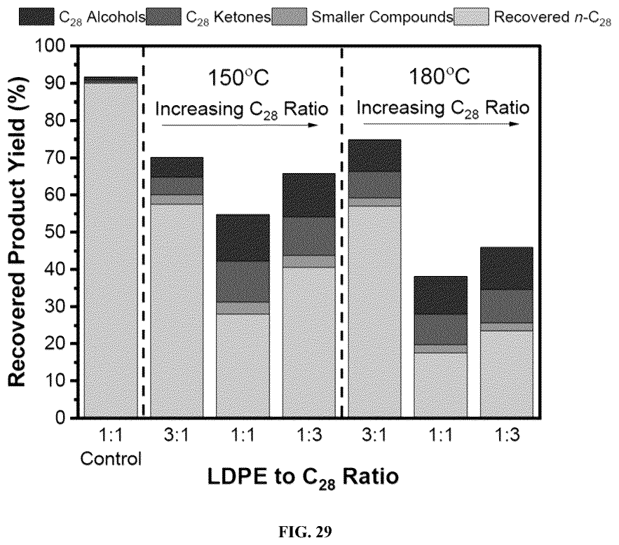

FIG. 29 shows the conversion and yield of the n-octacosane products. These long-chain oxygenates can be used for the production of surfactants and lubricants. To verify the hypothesis of the melt viscosity effect, the zero-shear (η₀) viscosities of the LPDE/C₂₈ blends were estimated (FIG. 25). Notably, the viscosity significantly dropped upon adding C₂₈; for example, at 150° C., the viscosity decreased by about 4× (to 0.98 from 4.34 Pa·s) upon adding 50 wt % C₂₈ (FIG. 24). Increasing the temperature of the 1:1 LDPE:C₂₈ blend decreased the viscosity from 0.98 Pa·s at 150° C. to 0.08 Pa·s at 180° C. (FIG. 24). Therefore, as long as the melt viscosity is low enough to allow diffusion of oxygen groups and counter diffusion of bulk melt, this plasma technique is capable of treating any depth of molten polymer, limited only by reactor configuration. Overall, the addition of long-chain alkanes facilitated the plasma oxidation of LDPE by reducing the viscosity of the melt.

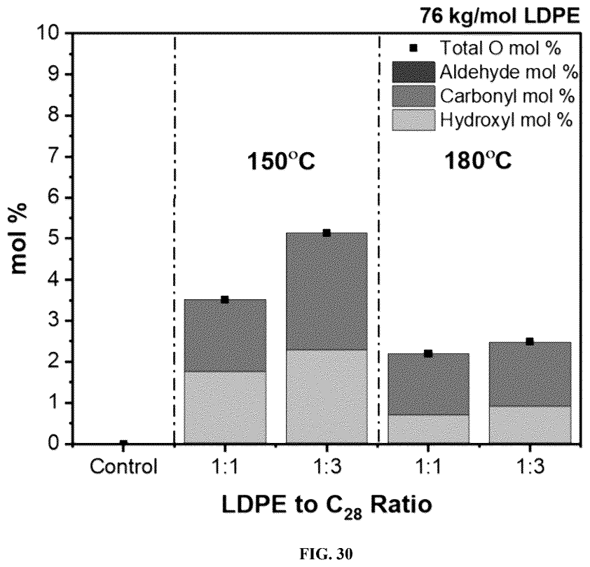

To further highlight the broad applicability of the NTAP functionalization strategy, a higher molecular-weight LPDE (about 76 kg mol⁻¹) was successfully oxidized at varying ratios (FIG. 30). Interestingly, higher oxidation was observed at a higher 1:3 LDPE:C₂₈ ratio at 150° C., attributed to the higher viscosity of the 76 kg mol⁻¹ LDPE. This simple, variable fraction of hydrocarbon addition is an effective strategy that could potentially be extended to high-density PE (HDPE) (M_{w} about 10² kg mol⁻¹) or ultra-high molecular weight PE (M_{w} about 10³ kg mol⁻¹), which are otherwise difficult to functionalize in bulk due to their extremely high viscosity.

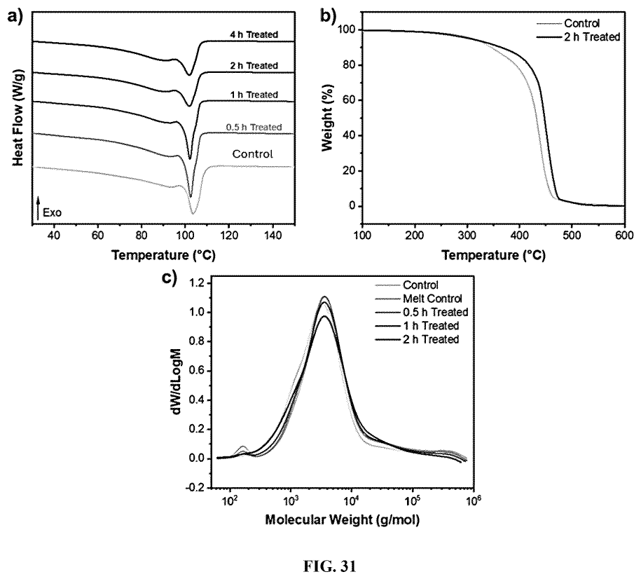

The physical and thermal properties of the LDPE were assessed after plasma treatment (FIG. 31). As hypothesized, the changes were similar to those observed in the plasma oxidation of PEWs. DSC traces indicated decreases in melting points and crystallinities, likely attributed to the introduction of oxygen groups, a reduction in the polymer molecular weight, and/or an increase in crosslinking. Melting temperatures, enthalpies, and crystallinities are listed in Table 2.

TABLE 2
Melting Temperature, Enthalpy, calculated Crystallinity,
and Gel Content for Neat and Plasma-oxidized
LDPE at Various Treatment Times

| | Melting Peak | | | |
|---|---|---|---|---|
| | Maximum | | Crystal- | Insoluble |
| | Temperature | Enthalpy of | linity | Fraction/Gel |
| Sample | (° C.) | Melting (J/g) | (%) | Content (%) |
| 40 kg/mol | 103.6 | 118.6 | 40.9 | 0 |
| Control | | | | |
| 40 kg/mol | 103.2 | 120.0 | 41.4 | — |
| 0.5 h | | | | |
| 40 kg/mol | 102.8 | 112.8 | 38.9 | — |
| 1 h | | | | |
| 40 kg/mol | 102.4 | 97.0 | 33.4 | 0.2 |
| 2 h | | | | |
| 40 kg/mol | 101.8. | 69.0 | 23.8 | 4.7 |
| 4 h | | | | |

Plasma operating conditions: treatment time: 0.5-4 h, O₂ feed molar percent: 2%, stir rate: 0 rpm, temperature: 150° C., and LDPE to C₂₈ ratio of 1:1.

Akin to results observed for PEWs, TGA measurements indicated an increased thermal stability of the plasma-oxidized LDPE, which is attributed to the crosslinking of the polymer chains. MWDs from HT-GPC indicated a minimal decrease in the molecular weight of LDPE by carbon cleavage (FIG. 31). From Soxhlet extraction in xylenes, the degree of crosslinking of the plasma-treated LDPE increased with prolonged treatment time. Polymers treated for 2 h and 4 h had insoluble fractions (i.e., gel contents) of 0.2% and 4.7%, respectively, compared to 0% for the neat LDPE control (Table 2). This mild increase in crosslinking vs. the control could contribute to the decrease in crystallinity; however, deconvoluting the effects of oxidation, reduction (from NMR), crosslinking, and other chain modifications on the thermal properties of the LDPE remains difficult due to the complex reactions that occur during plasma treatment. These findings also indicated almost complete removal of n-C₂₈ from the resulting oxidized LDPE by simple extraction methods, which would be evident in DSC and HT-GPC characterizations due to its low melting point (about 61° C.) and molecular weight (M_{w} about 395 g mol⁻¹) compared to LDPE (110° C., M_{w} about 40 kg mol⁻¹).

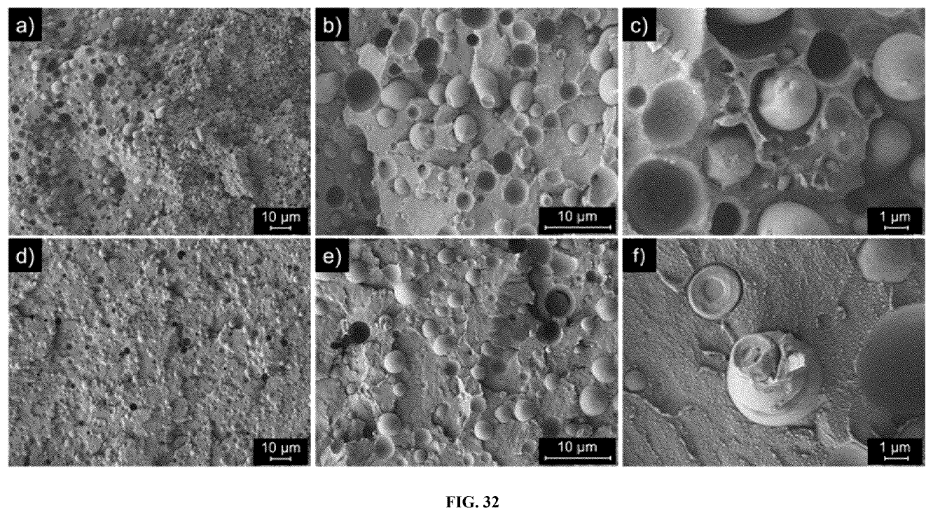

The ability of the plasma-oxidized LDPE to serve as a polymer compatibilizer was then explored. A non-polar LDPE (76 kg mol⁻¹) and polar PLA were melt-blended with 5 wt % neat LDPE (40 kg mol⁻¹) or 2 h plasma-oxidized LDPE (3.5 mol % oxygen incorporation, M_{w} about 40 kg mol⁻¹). Because PLA and LDPE phase-separate from their poor interfacial adhesion, these blend systems were chosen to determine the plasma-oxidized LDPE's ability to function as a polymer compatibilizer. Scanning electron microscopy (SEM) imaging demonstrated the polymer blend morphology upon incorporating the compatibilizer. FIG. 32 shows SEM images of the LDPE/PLA blends containing 5 wt % of neat, non-oxidized LDPE; both samples displayed a droplet-in-matrix morphology (see (a)-(c) of FIG. 32). Clear phase separation was evident between PLA (secondary phase—circular droplets) and LDPE (primary phase—surrounding polymer matrix). Low magnification images (×600, see (a) of FIG. 32) indicated a highly perforated cross-section of the polymer blend resulting from the distinct PLA and LDPE phases. Small voids between phases were manifested at closer magnifications (FIGS. 6b and c) due to poor interfacial adhesion. FIG. 32 also illustrates images upon adding the 5 wt % plasma-oxidized LDPE to the PLA/LDPE blend (see (d)-(f) of FIG. 32). At low magnification (see (d) of FIG. 32), a less perforated, more homogeneous cross-section was evident. Closer magnifications (see (e)-(f) of FIG. 32) indicated improved interfacial adhesion (compared to blends containing unfunctionalized LDPE), as the plasma-oxidized LDPE enhanced interactions between PLA and LDPE due to polar and non-polar functional groups. The above results suggested that the oxygen-rich regions in the treated LDPE were responsible for enhancing interfacial adhesion between the two phases. The OH groups in the functionalized LDPE were hypothesized to function as hydrogen-bond donors to interact with the CvO bonds in PLA, which were hypothesized to function as the acceptors.

TGA and DSC were conducted on PLA/LDPE blends (Table 3) to investigate the impact of the oxidized LDPE on the thermal properties of the blends.

TABLE 3
Properties of PLA/LDPE blends

| | T_{mLDPE} | T_{mPLA} | T_{g} | X_{c}_{_{—}}_{PLA} | X_{c}_{_{—}}_{LDPE} | T_{c} |
|---|---|---|---|---|---|---|
| Sample | (° C.) | (° C.) | (° C.) | (%) | (%) | (° C.) |
| PLA | — | 147.1/152.0 | 52.5 | 33.3 | — | — |
| LDPE | 111.6 | — | — | — | 35.0 | 98.9 |
| LDPE40/LDPE/PLA | 109.1 | 145.6/151.9 | 52.0 | 23.7 | 32.9 | 98.3 |
| O-LDPE40/LDPE/PLA | 110.3 | 144.3/151.9 | 52.6 | 23.3 | 29.9 | 98.8 |

The glass transition temperature (T_{g}) of PLA (about 55° C.) was determined from the 2^{nd} heating DSC traces and remained unchanged in all PLA/LDPE blends (Table 3). Distinct T_{g}s indicated an immiscible, phase-separated blend, and the unchanged PLA T_{g} aligned with observations from SEM images (FIG. 32). The PLA control and the PLA-containing blend samples displayed bimodal endotherms corresponding to the melting of PLA crystalline domains at about 146 and about 150° C. (Table 3). This bimodal melting behavior is typically observed for PLA due to ordered and less ordered crystal structures (e.g., α and α′ crystals) or differing crystal structures (e.g., α, β, γ). In some cases, bimodal endotherms in immiscible blends can result from morphological constraints of the semi-crystalline material as interfaces can act as secondary nucleation sites; however, the bimodal melting peak was also observed in the PLA control sample. A slight suppression in LDPE melting temperature (from 112° C. for neat LDPE to 109-110° C. for the blends) was seen upon inclusion of the lower molecular weight LDPE (40 kg mol⁻¹) (Table 3).

The crystallinity of the PLA phase decreased in blended samples relative to neat PLA (23.7% for the control and 23.3% for the oxidized-LDPE-containing sample vs. 33.3% in neat PLA) (Table 3). This behavior was similar for the LDPE crystallinity (32.9% for the control and 29.9% for the oxidized-LDPE-containing sample vs. 35.0% in neat LDPE) (Table 3). The mild decrease in crystallinity of the blends vs. the neat polymers can be explained by the interface between phases. The interface or enhanced interfacial interactions can disrupt the crystalline packing of each polymer by hindering chain mobility or nucleation, ultimately suppressing the overall crystallinity. The slightly lower crystallinity in the oxidized-PE-containing sample (vs. the non-oxidized-PE-containing sample) could be indicative of an increase in the quantity or nature of interfacial interactions (FIG. 32) or the lower crystallinity of the oxidized LDPE used (0.2% gel content, Table 2). Investigating the crystal structure and crystallization kinetics across varying PLA/LDPE/compatibilizer ratios could be leveraged to elucidate these complex interfacial phenomena further.

All blends exhibited similar thermal stability as revealed by TGA analyses. A two-stage degradation process was observed for all samples, corresponding first to the degradation of PLA followed by that of LDPE. Additionally, the plasma-oxidized, compatibilized PLA/LDPE blends showed slightly higher thermal stability compared to the control, which could be due to crosslinking in the LDPE (0.2% gel content, Table 2) or enhanced interactions from compatibilization of the blend.

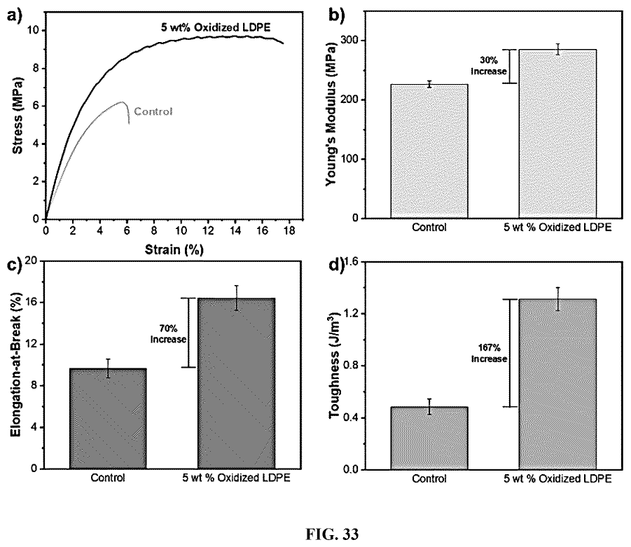

Tensile testing of the PLA/LDPE blends was conducted to assess mechanical behavior with or without the incorporation of the plasma-oxidized LDPE (FIG. 33). Typically, the mechanics of an immiscible blended system are governed by the interphase quality and its ability to dissipate stress and prevent crack propagation through appropriate stress transfer. For example, well-dispersed, small secondary phases have superior stress-transfer abilities relative to those with larger secondary phases, which can act as stress concentrators. Additionally, voids created by poor interfacial adhesion or contact minimize stress transfer and result in inferior mechanical properties.

All PLA/LDPE blends containing plasma-oxidized LDPE as a compatibilizer displayed improved tensile properties compared to controls with non-oxidized LDPE (FIG. 33). The neat PLA displayed brittle behavior characterized by a Young's modulus of 982.4 MPa, an elongation-at-break of 3.2%, and a toughness of 0.55 J m⁻³ owing to its T_{g} (about 53° C.) (Table 3, Table 4).

TABLE 4
Mechanical Properties of Neat PLA and LDPE, the Control PLA/LDPE
Blend, the Blend containing 5 wt % Oxidized LDPE as a Compatibilizer,
and a Blend Compatibilized with 5 wt % LDPE-gMAH

| | Ultimate | | | | |
|---|---|---|---|---|---|
| | Tensile | Young's | Stress-at- | | |
| | Strength | Modulus | break | εbreak | Toughness |
| Sample | (MPa) | (MPa) | (MPa) | (%) | (MJ m⁻³) |
| PLA | 19 ± 3 | 982 ± 98 | 13.5 ± 0.5 | 3.1 ± 0.4 | 0.6 ± 0.1 |
| LDPE | 8.4 ± 0.2 | 169 ± 11 | 1.8 ± 0.1 | 85.5 ± 1.8 | 6.0 ± 0.4 |
| LDPE40/LDPE/PLA | 6.5 ± 0.1 | 227 ± 6 | 5.5 ± 0.2 | 9.7 ± 0.9 | 0.5 ± 0.1 |
| O-LDPE40/LDPE/PLA | 9.7 ± 0.2 | 285 ± 9 | 8.7 ± 0.2 | 16.4 ± 1.2 | 1.3 ± 0.1 |
| LDPE40- | 7.6 ± 0.2 | 206 ± 8 | 3.2 ± 0.5 | 26.4 ± 2.3 | 0.8 ± 0.2 |
| gMAH/LDPE/PLA | | | | | |

In contrast, the neat LDPE exhibited ductile behavior characterized by a Young's modulus of 169.2 MPa, an elongation-at-break of 85.5%, and a toughness of 6.0 J m⁻³ (Table 4). The control blend (LDPE, PLA, and 5 wt % non-oxidized LDPE) had a Young's modulus of 226.7 MPa, an elongation-at-break of 9.7%, and a toughness of 0.5 J m⁻³. The resulting low elongation-at-break (vs. the primary LDPE phase) indicates an immiscible polymer blend with poor interfacial stress transfer and/or propagation. Introducing 5 wt % oxidized LDPE as a compatibilizer increased both Young's modulus by 30% (from 226.7 MPa to 285.4 MPa) and the elongation-at-break (from 9.7% to 16.4%) relative to the non-oxidized LDPE-containing control blend (FIG. 33 and Table 4). The Young's modulus of the PE could have increased during the oxidation process due to the balance between crosslinking and scission reactions. Chain scission processes can reduce crystallinity by lowering the molecular weight and disrupting regular packing (FIGS. 16-18 and Table 3), while the formation of crosslinks (Table 2) and polar groups also can result in strengthening the amorphous regions. Together, these effects could have been responsible for the increase in the Young's modulus of the compatibilized system vs. the system containing the non-oxidized PE. This enhancement in Young's modulus and elongation-at-break values increased the toughness of the blends, defined as the amount of energy the sample can absorb before rupturing and calculated by integrating the area under the stress-strain curve.

A 167% toughness increase in the oxidized blend over the control blend was observed (1.3 vs. 0.5 J m⁻³) (FIG. 33, Table 4). Additionally, the plasma-compatibilized blends were compared to a blend compatibilized with LDPE grafted with maleic anhydride (LDPE-gMAH), demonstrating a higher Young's modulus (285 vs. 206 MPa) and ultimate tensile strength (9.7 vs. 7.6 MPa), but a lower elongation-at-break (16.4 vs. 26.4%) at identical loadings (5 wt %). The adding of the oxidized-LDPE or LDPE-gMAH compatibilizer was hypothesized to be responsible for the improvements in the interfacial interactions and phase-phase adhesion (vs. the non-oxidized-LDPE containing control), thus facilitating stress transfer and improving the mechanical properties. This hypothesis is supported by SEM imaging, which shows a decrease in the repulsion between the LDPE and PLA phase and/or the number of visible voids (FIG. 32). Other mechanical testing parameters, such as ultimate tensile strength and stress-at-break, also improved for oxidized blends (Table 4).

To support the hypothesis regarding how the improved interfacial interactions occurred upon the addition of oxidized-LDPE to the PLA/LDPE blends, the interfacial tension between the blend components was estimated according to Wu's method. The addition of the plasma oxidized-LDPE to the PLA/LDPE blend reduced the estimated interfacial tension between PLA and LDPE from 3.81 to 2.95 mJ m⁻² (Table 5).

TABLE 5
Dispersive and Polar Components and Total Interfacial
Tension from Contact Angle Analysis of PLA, LDPE, and
LDPE + O-LDPE Samples with Water and Ethylene Glycol

| | γ ^{d} | γ ^{p} | γ ^{total} |
|---|---|---|---|
| Sample | (mN/m²) | (mN/m²) | (mN/m²) |
| PLA | 14.4 | 12.5 | 27.0 |
| LDPE | 21.9 | 6.0 | 27.9 |
| LDPE + | 8.5 | 19.2 | 27.7 |
| O-LDPE | | | |

This reduction in the interfacial tension is attributed to an increase in the polar component (γ^{p}) and a decrease in the dispersive component (γ^{d}) of the interfacial tension of the base LDPE (from 6.0 to 19.2, and 21.9 to 8.5 mN m⁻², respectively) upon oxidized-LDPE incorporation (Table 6). Since the final blends included unfunctionalized or functionalized LDPE (about 40 kg mol⁻¹), the improvement in mechanical properties was attributed directly to the oxygen groups along the polymer backbone of the plasma-treated material and the resulting reduced interfacial tension when blended with PLA.

TABLE 6
Estimated Interfacial Tension between Blends
of PLA and LDPE with and without Inclusion
of a Plasma-functionalized LDPE Compatiblizer

| | Interfacial Tension |
|---|---|
| Sample | [γ _{1, 2}] (mJ/m²) |
| PLA/LDPE | 3.81 |
| PLA/LDPE + | 2.95 |
| O-LDPE | |

### Example 1 Conclusions

In summary, the results of the experiments conducted in this example demonstrated that plasma-induced, controlled oxidative functionalization of bulk PEW and PE of varying molecular weights is possible by incorporating primarily hydroxyl and carbonyl (ketone and aldehyde) groups across the polymer backbone. The melting point, crystallinity, and molecular weight of the waxes decreased at elevated degrees of oxidation. In contrast, their thermal stability slightly increased, indicating an interplay between chain oxidation, scission, and cross-linking reactions. Compared to commercial oxidized waxes synthesized at high temperatures and pressures, plasma-oxidized waxes achieve similar acid numbers and oxidation percentages while featuring an increased diversity of functional groups.

Direct extension to higher molecular weight polymers, such as LDPE of 40 and 76 kg mol⁻¹, is challenging due to the high bulk polymer melt viscosity. Controllable plasma oxidation occurs upon adding a long hydrocarbon (e.g., n-octacosane) as a viscosity modifier to the LDPE melt, which could be easily removed by simple extraction methods. This viscosity modification provided a general strategy to achieve bulk functionalization of plastic waste, allowing waste upcycling and circularity across a broad range of polymer resin codes. Additionally, the long hydrocarbons can be produced by mild hydrogenolysis, and their oxidized products can be leveraged for several product markets. The plasma-oxidized LDPE can act as a compatibilizer for various phase-separating polymers such as LDPE and PLA polymer blends. The incorporation of 5 wt % plasma-oxidized LDPE led to enhanced interfacial adhesion of the PLA/LDPE blend, as evidenced by SEM imaging and improved mechanical properties (70% increase in elongation-at-break values and 167% increase in toughness vs. the control blend). The compatibilization strategy explored in this example could be extended to other immiscible systems representative of waste streams, such as poly(ethylene terephthalate)/polyolefin blends, by enhancing the polarity of the non-polar phase. Moreover, plasma modification enhances the polarity of LDPE (3.2-fold increase in γ^{p}), rendering it potentially suitable as a binding interlayer between polar and non-polar plastics for adhesion purposes.

In terms of catalyst-free oxidation, current strategies typically include traditional thermal oxidation, biological/enzymatic oxidation, photochemical oxidation, and NTAP oxidation. Although traditional thermal oxidation has high scaling potential, it lacks selectivity due to overoxidation and requires significant energy input to activate C—H bonds. Biological/enzymatic oxidation has shown some success at low energy costs; however, it is difficult to scale and suffers from slow reaction rates. Photochemical oxidation can also operate at low energy costs, but it is challenging to scale and is limited by slow reaction rates due to UV penetration constraints, making it primarily a surface oxidation technique. Similarly, due to penetration constraints, conventional NTAP methods focus purely on surface oxidation techniques and usually require expensive vacuum systems, which are difficult to scale.

The NTAP oxidation method explored in the above example and disclosed herein operate under atmospheric conditions and are capable of bulk polymer oxidation with high selectivity, overcoming a significant barrier. Additionally, due to the relatively simple configuration, this plasma process offers a decentralized approach to upcycling plastics waste, and implementation into plastics recycling plants could be potentially easier compared to other technologies. A numbering-up strategy is well-suited for these smaller configurations, such as an array of pins impinging on a liquid surface or employing multiple plasma reactors in parallel, to increase production. Optimizing the reactor geometry to increase the plasma-liquid interface, such as bubbling or use of microfluidics, can decrease the residence time and increase the production rate of oxidized LDPE. However, this approach requires significant addition of viscosity modifiers to achieve efficient bulk oxidation, which necessitates downstream separations and raises potential scaling concerns. These challenges can be partially mitigated by using viscosity modifiers derived from more renewable sources (e.g., PEWs) or by developing processes that do not require purified oxidized LDPE and can benefit from smaller hydrocarbon incorporation. Overall, this work opens a new avenue for utilizing plasma in chemical manufacturing, particularly for the upcycling of plastics waste, and showcases a promising green, catalyst-free process for valorizing plastics waste that could be trialed for a broad range of plastics and associated blends and several hard-to-manufacture products.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

1. A method for oxidizing a polymer or wax comprising:
placing and melting the polymer or wax on a ground electrode or on a dielectric between electrodes;
supply a power and a gas mixture to a high-voltage electrode positioned above the ground electrode or dielectric; and
subjecting the polymer or wax on the ground electrode or dielectric to a non-thermal atmospheric plasma process until an oxidized polymer or wax forms.

2. The method of claim 1, wherein the polymer on the ground electrode or dielectric is subjected to the non-thermal atmospheric plasma process for about 0 h to about 24 h.

3. The method of claim 1, wherein the power supplied to the high-voltage electrode ranges from about 0.1 W to about 5.0 W.

4. The method of claim 1, wherein the gas mixture includes atmospheric oxygen, helium or combinations thereof.

5. The method of claim 1, wherein the non-thermal atmospheric plasma process occurs at a temperature ranging from about 100° C. to about 300° C.

6. The method of claim 1, wherein the non-thermal atmospheric plasma process is conducted under a stirring rate of 0 rpm to about 600 rpm.

7. The method of claim 1, wherein the non-thermal atmospheric plasma process occurs under a O₂ feed molar fraction of about 0% to about 100%.

8. The method of claim 1, wherein the non-thermal atmospheric plasma process incorporates about 4 mol % to about 10 mol % oxygen into a backbone of the polymer as hydroxyl, carbonyl, and aldehyde groups.

9. The method of claim 1, wherein the oxidized polymer contains an acid number ranging from about 3 to about 20.

10. The method of claim 1, wherein the oxidized polymer contains, based on a total molar percentage of oxygen groups present in the oxidized polyethylene polymer, about 0.5 mol % to about 70 mol % alcohol groups, about 0.5 mol % to about 70 mol % carbonyl groups and about 0.5 mol % to about 10 mol % aldehyde groups.

11. The method of claim 1, wherein the polymer or wax is selected from the group consisting of a polyethylene wax, a high-density polyethylene (HDPE), a low-density polyethylene (LDPE), a linear low-density polyethylene (LLDPE), a ultra-high-molecular-weight polyethylene (UHMWPE), a polypropylene polymer or wax, a polystyrene polymer or wax and combinations thereof.

12. The method of claim 1, wherein the polymer placed on the ground electrode or dielectric is part of a solution that also contains at least one solvent.

13. The method of claim 12, wherein the solvent is n-octacosane or an alkane possessing one or more of the following: a) a melting temperature below 100° C., b) a degradation temperature above 200° C., and/or c) the ability to form a single-phase solution with the polymer.

14. The method of claim 12, wherein the solution contains a ratio of polyethylene polymer-to-solvent of about 1:3 to about 3:1.

15. A polymer blend comprising one or more additional polymers, at least one oxygen-atom-containing polymer, and at least one oxidized polymer or wax produced by the method according to claim 1.

16. The polymer blend of claim 15, wherein the blend comprises about 0.1 wt % to about 10 wt % of the oxidized polymer or wax, about 20 wt % to about 30 wt % of the at least one oxygen-atom-containing polymer, and about 60 wt % to about 70 wt % of the one or more additional polymers.

17. The polymer blend of claim 15, wherein the at least one oxygen-atom-containing polymer is poly(lactic acid).

18. The polymer blend of claim 15, wherein the polymer blend possesses a strain-at-break that is at least 70% higher than a strain-at-break of a comparable polymer blend,
wherein the comparable polymer blend contains the one or more additional polymers and the at least one oxygen-containing polymer of the polymer blend in the same weight percentages as the polymer blend, and contains at least one non-oxidized polymer or wax instead of the at least one oxidized polymer or wax of the polymer blend, wherein the at least one non-oxidized polymer or wax is present in the comparable polymer blend in a weight percentage that is the same as the weight percentage that the at least one oxidized polymer or wax contributes to the polymer blend.

19. The polymer blend of claim 15, wherein the polymer blend possesses a Young's modulus that is at least 30% higher than a Young's modulus of a comparable polymer blend,
wherein the comparable polymer blend contains the one or more additional polymers and the at least one oxygen-containing polymer of the polymer blend in the same weight percentages as the polymer blend, and contains at least one non-oxidized polymer or wax instead of the at least one oxidized polymer or wax of the polymer blend, wherein the at least one non-oxidized polymer or wax is present in the comparable polymer blend in a weight percentage that is the same as the weight percentage that the at least one oxidized polymer or wax contributes to the polymer blend.

20. The polymer blend of claim 15, wherein the polymer blend possesses a toughness that is at least 160% higher than a toughness of a comparable polymer blend,
wherein the comparable polymer blend contains the one or more additional polymers and the at least one oxygen-containing polymer of the polymer blend in the same weight percentages as the polymer blend, and contains at least one non-oxidized polymer or wax instead of the at least one oxidized polymer or wax of the polymer blend, wherein the at least one non-oxidized polymer or wax is present in the comparable polymer blend in a weight percentage that is the same as the weight percentage that the at least one oxidized polymer or wax contributes to the polymer blend.

21. An article produced from or comprising the oxidized polymer or wax of claim 1, wherein the article is a paint, a coating, a compatibilizer for plastic blends, a grafted polymer, an adhesive, an emulsifier, a floor polish, an ink, a textile, a lubricant, or a resin.
